(19) United States
(12) Patent Application Publication
(10) Pub. No.: US 2026/0313390 A1
(43) Pub. Date: Oct. 8, 2026

(54) METHOD AND APPARATUS FOR CONTROLLING OPERATION MODE OF WIRELESS REPEATER IN WIRELESS COMMUNICATION SYSTEM

(71) Applicant: ELECTRONICS AND TELECOMMUNICATIONS RESEARCH INSTITUTE, Daejeon (KR)

(72) Inventors: Hoondong NOH, Daejeon (KR); Hyung Sik JU, Daejeon (KR)

(73) Assignee: ELECTRONICS AND TELECOMMUNICATIONS RESEARCH INSTITUTE, Daejeon (KR)

(21) Appl. No.: 19/400,945

(22) Filed: Nov. 25, 2025

(30) Foreign Application Priority Data
Nov. 25, 2024 (KR) 10-2024-0170089
Nov. 24, 2025 (KR) 10-2025-0179073

(51) Int. Cl. H04W 24/02; H04L 5/00; H04L 5/14; H04W 64/00

(52) U.S. Cl. CPC H04W 24/02; H04L 5/0051; H04L 5/14; H04W 64/00

(57) ABSTRACT

A method of a repeater may comprise: performing a first relay operation between a first base station and a first terminal based on first configuration information for a first operation mode received from the first base station; performing a second relay operation between a second base station and a second terminal based on second configuration information for a second operation mode received from the second base station; and based on a preconfigured condition being satisfied, stopping the second relay operation, wherein the preconfigured condition is received from the first base station through signaling.

### CROSS-REFERENCE TO RELATED APPLICATIONS

This application claims priority to Korean Patent Applications No. 10-2024-0170089, filed on Nov. 25, 2024, and No. 10-2025-0179073, filed on Nov. 24, 2025, with the Korean Intellectual Property Office (KIPO), the entire contents of which are hereby incorporated by reference.

### BACKGROUND

### 1. Technical Field

The present disclosure relates to a wireless repeater technique in a wireless communication system, and more particularly, to a technique for controlling an operation mode of a wireless repeater.

### 2. Related Art

In 5G new radio NR or future mobile communication systems such as 6G, introduction of a network-controlled repeater NCR controlled by a base station has been actively discussed in order to overcome limitations of a conventional radio frequency RF repeater that simply amplifies and retransmits a received signal.

In addition to a device for amplification and retransmission of a received signal, the network-controlled repeater may include devices for receiving control signals from a base station and transmitting responses to the control signals to the base station. The added devices may include devices for controlling or managing the network-controlled repeater to operate in various duplex modes such as time division duplexing (TDD), frequency division duplexing (FDD), subband non-overlapping full duplex (SBFD), and full duplex (FD).

In the 5G NR standard up to 3GPP Rel-18, the network-controlled repeater is allowed to operate only in a specific duplex mode such as FDD or semi-static TDD. As a result, in a network operating additional duplex modes such as dynamic TDD or SBFD, coverage in the additional duplex modes may be limited.

### SUMMARY

The present disclosure is directed to providing methods for operating a network-controlled repeater in a network in which various duplex modes coexist, in order to increase wireless network performance gains achieved through the network-controlled repeater.

A method of a repeater, according to an exemplary embodiment of the present disclosure, may comprise: performing a first relay operation between a first base station and a first terminal based on first configuration information for a first operation mode received from the first base station; performing a second relay operation between a second base station and a second terminal based on second configuration information for a second operation mode received from the second base station; and based on a preconfigured condition being satisfied, stopping the second relay operation, wherein the preconfigured condition is received from the first base station through signaling.

The preconfigured condition may be satisfied based on a second distance between the second base station and the repeater being longer than a first distance between the first base station and the repeater.

The first distance and the second distance may be radio distances based on signal attenuation, respectively.

The first distance may be a geometric distance between the repeater and the first base station, and the second distance may be a geometric distance between the repeater and the second base station.

The first distance may be calculated using location information of the first base station included in the first configuration information and location information of the repeater, the second distance may be calculated using location information of the second base station included in the second configuration information and the location information of the repeater, and the location information of the repeater may be obtained from global navigation satellite system (GNSS) information or may be obtained based on a reference signal (RS) received from one of the first base station or the second base station.

The preconfigured condition may be satisfied based on a second distance between the second base station and the repeater being greater than a preconfigured second threshold.

The preconfigured condition may be satisfied based on a first distance between the first base station and the repeater being smaller than a preconfigured first threshold.

The preconfigured condition may be satisfied based on resources for the first relay operation according to the first configuration information overlapping at least partially with resources for the second relay operation according to the second configuration information.

The preconfigured condition may be satisfied based on the second relay operation being invalid at a specific time.

The first operation mode may be one of a time division duplexing (TDD) mode, a frequency division duplexing (FDD) mode, or a semi-static TDD mode, and the second operation mode may be one of a dynamic TDD mode, a subband non-overlapping full duplex (SBFD) mode, or an inband full duplex (FD) mode.

A repeater, according to an exemplary embodiment of the present disclosure, may comprise at least one processor, wherein the at least one processor may cause the repeater to perform: performing a first relay operation between a first base station and a first terminal based on first configuration information for a first operation mode received from the first base station; performing a second relay operation between a second base station and a second terminal based on second configuration information for a second operation mode received from the second base station; and based on a preconfigured condition being satisfied, stopping the second relay operation, wherein the preconfigured condition is received from the first base station through signaling.

The preconfigured condition may be satisfied based on a second distance between the second base station and the repeater being longer than a first distance between the first base station and the repeater.

The first distance and the second distance may be radio distances based on signal attenuation, respectively.

The first distance may be a geometric distance between the repeater and the first base station, and the second distance may be a geometric distance between the repeater and the second base station.

The first distance may be calculated using location information of the first base station included in the first configuration information and location information of the repeater, the second distance may be calculated using location information of the second base station included in the second configuration information and the location information of the repeater, and the location information of the repeater may be obtained from global navigation satellite system (GNSS) information or may be obtained based on a reference signal (RS) received from one of the first base station or the second base station.

The preconfigured condition may be satisfied based on a second distance between the second base station and the repeater being greater than a preconfigured second threshold.

The preconfigured condition may be satisfied based on a first distance between the first base station and the repeater being smaller than a preconfigured first threshold.

The preconfigured condition may be satisfied based on resources for the first relay operation according to the first configuration information overlapping at least partially with resources for the second relay operation according to the second configuration information.

The preconfigured condition may be satisfied based on the second relay operation being invalid at a specific time.

The first operation mode may be one of a time division duplexing (TDD) mode, a frequency division duplexing (FDD) mode, or a semi-static TDD mode, and the second operation mode may be one of a dynamic TDD mode, a subband non-overlapping full duplex (SBFD) mode, or an inband full duplex (FD) mode.

According to an exemplary embodiment of the present disclosure, when signals from base stations operating in different modes are relayed to terminal(s), methods capable of reducing interference caused by different operation modes can be provided. In particular, when a first operation mode is allocated to cover both urban areas and suburban areas, and a second operation mode is allocated to cover only the suburban areas in which uplink coverage issues are more prominent, an effect of reducing interference on other operation modes can be achieved by limiting signal amplification of a repeater at a boundary region of an area covered by a specific operation mode. Alternatively, interference on other operation modes can be blocked by stopping a relay operation for the second operation mode. In addition, by determining validity such as whether terminals according to the second operation mode exist, an effect of reducing retransmission load of the system can be achieved. Furthermore, a decision to stop the relay operation for the second operation mode can be made by determining an interference impact based on distances to base stations of other operation modes. Accordingly, an effect of expanding coverage of a base station as well as an effect of increasing transmission efficiency can be achieved.

### BRIEF DESCRIPTION OF DRAWINGS

FIG. 1 is a conceptual diagram illustrating an exemplary embodiment of a radio interface protocol structure in a communication system.

FIG. 2 is a conceptual diagram illustrating an exemplary embodiment of time resources in which radio signals are transmitted in a communication system.

FIG. 3 is a conceptual diagram illustrating a time difference between a reception timing of an i-th downlink frame and a transmission timing of an i-th uplink frame in an exemplary embodiment of a communication system.

FIG. 4 is a conceptual diagram illustrating an exemplary embodiment of a time/frequency resource grid of a communication system.

FIG. 5 is a conceptual diagram illustrating an exemplary embodiment of a synchronization signal and physical broadcast channel (SS/PBCH) block of a communication system.

FIG. 6 is a sequence chart illustrating an exemplary embodiment of a random access procedure in a communication system.

FIG. 7 is a conceptual diagram illustrating a first exemplary embodiment of SSB-RO association according to RACH configuration in a communication system.

FIG. 8 is a conceptual diagram illustrating a second exemplary embodiment of SSB-RO association according to RACH configuration in a communication system.

FIG. 9 is a conceptual diagram illustrating an exemplary embodiment of a QCL information transfer process through TCI state configuration and indication in a communication system.

FIG. 10 is a conceptual diagram illustrating an exemplary embodiment of a TCI state activation/deactivation MAC CE in a communication system.

FIG. 11 is a conceptual diagram illustrating an exemplary embodiment of a TCI state indication MAC CE in a communication system.

FIG. 12 is a conceptual diagram illustrating slot configurations according to slot formats in a communication system.

FIG. 13 is a sequence chart illustrating an exemplary embodiment of a UE capability reporting procedure in a communication system.

FIG. 14A is a conceptual diagram for describing a first exemplary embodiment of a user plane protocol stack structure in a communication system.

FIG. 14B is a conceptual diagram for describing a first exemplary embodiment of a control plane protocol stack structure in a communication system.

FIG. 15 is a conceptual diagram for describing slot formats within a given time duration in a 5G NR system.

FIG. 16 is a conceptual diagram illustrating deployment of a commercial RF repeater.

FIG. 17 is a conceptual diagram illustrating a protocol stack for a control plane and a user plane of a wireless communication system including an RF repeater.

FIG. 18 is a conceptual diagram for describing deployment of a network control repeater.

FIG. 19A is a conceptual diagram illustrating an example of a control plane protocol stack of an advanced repeater according to an exemplary embodiment of the present disclosure.

FIG. 19B is a conceptual diagram illustrating an example of a user plane protocol stack of an advanced repeater according to an exemplary embodiment of the present disclosure.

FIG. 20A is a conceptual diagram illustrating examples of a temporal part of a single-beam priority determination method according to an exemplary embodiment of the present disclosure.

FIG. 20B is a conceptual diagram illustrating examples of a remaining part of the single-beam priority determination method according to an exemplary embodiment of the present disclosure.

FIG. 21 is a conceptual diagram for describing a method in which a base station allocates time-frequency resources to a terminal according to an operation mode.

FIG. 22 is a conceptual diagram for describing an example of controlling a repeater in consideration of an operation mode according to an exemplary embodiment of the present disclosure.

FIG. 23A is a conceptual diagram for describing a method of defining a physical location in which an operation mode is operated according to an exemplary embodiment of the present disclosure.

FIG. 23B is a conceptual diagram for describing a case of controlling a repeater in consideration of an operation mode according to an exemplary embodiment of the present disclosure.

FIG. 24A is a conceptual diagram illustrating a first exemplary embodiment of controlling a repeater in consideration of operation modes supported by terminals according to the present disclosure.

FIG. 24B is a conceptual diagram illustrating a second exemplary embodiment of controlling a repeater in consideration of operation modes supported by terminals according to the present disclosure.

FIG. 24C is a conceptual diagram illustrating a third exemplary embodiment of controlling a repeater in consideration of operation modes supported by terminals according to the present disclosure.

FIG. 25 is a sequence diagram for describing an operation of an NCR according to an exemplary embodiment of the present disclosure.

FIG. 26 is a conceptual diagram of a base station configuration according to an exemplary embodiment of the present disclosure.

FIG. 27 is a conceptual diagram of a repeater configuration according to an exemplary embodiment of the present disclosure.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

In the present disclosure, “(re) transmission” may refer to “transmission”, “retransmission”, or “transmission and retransmission”, “(re) configuration” may refer to “configuration”, “reconfiguration”, or “configuration and reconfiguration”, “(re) connection” may refer to “connection”, “reconnection”, or “connection and reconnection”, and “(re) access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e. “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

A communication network to which exemplary embodiments according to the present disclosure are applied will be described. The communication network to which the exemplary embodiments according to the present disclosure are applied is not limited to the contents described below, and the exemplary embodiments according to the present disclosure may be applied to various communication networks. Here, the communication network may have the same meaning as a communication system. A communication network may refer to a wireless communication network, and a communication system may refer to a wireless communication system.

In the present disclosure, “configuration of an operation (e.g. transmission operation)” may refer to signaling of “control information (e.g. information element, parameter) for the operation” and/or “information indicating to perform the operation”. “An information element (e.g. parameter) is configured” may mean that the corresponding information element is signaled. In the present disclosure, signaling may be at least one of system information (SI) signaling (e.g. transmission of a system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)).

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g. 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multi-hop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

In particular, the present disclosure described below may provide methods for determining a transmission direction of an uplink and/or a downlink of a terminal in a full-duplex communication system.

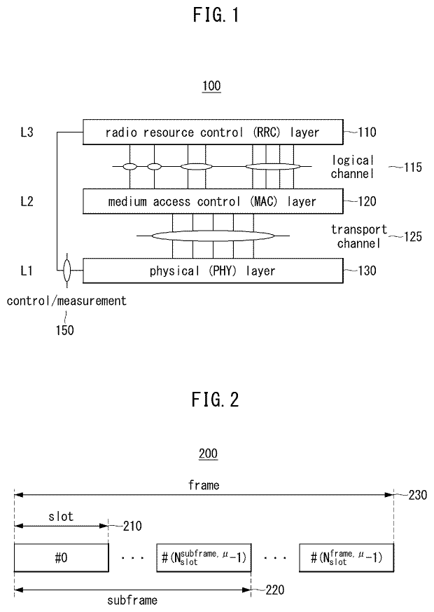

FIG. 1 is a conceptual diagram illustrating an exemplary embodiment of a radio interface protocol structure in a communication system.

Referring to FIG. 1, an exemplary embodiment of a radio interface protocol structure 100 of a communication system may be configured to include a radio resource control (RRC) layer 110, a medium access control (MAC) layer 120, a physical (PHY) layer 130, and the like. An exemplary embodiment of the radio interface protocol structure 100 shown in FIG. 1 may correspond to various exemplary embodiments of interfaces such as an interface between a terminal and a base station, an interface between an IAB-node distributed unit (IAB-DU) and an IAB-node mobile terminal (IAB-MT) of an integrated access backhaul (IAB) network, an interface between an IAB-DU and a lower node, an interface between an IAB-MT and an upper node, an interface between a plurality of terminals, and the like.

In the vicinity of the PHY layer 130, the RRC layer 110, and the MAC layer 120, and the like may be disposed above the PHY layer 130. For example, the MAC layer 120 may be disposed above the PHY layer 130. The RRC layer 110 may be disposed above the MAC layer 120.

The MAC layer 120 may be connected to a higher layer (e.g. RRC layer 110) through logical channels 115. The PHY layer 130 may be connected to the higher MAC layer 120 through transport channels 125. The PHY layer 130 may transmit and receive control information or measurement information 150 to and from the RRC layer 110.

The PHY layer 130 may be referred to as a ‘layer 1’ or ‘L1’. The MAC layer 120 may be referred to as a ‘layer 2’ or ‘L2’. The RRC layer 110 may be referred to as a ‘layer 3’ or ‘L3’. The RRC layer 110 and the MAC layer 120 may be collectively referred to as the ‘higher layer’.

In the present disclosure, ‘L1 signaling’ refers to signaling such as downlink control information (DCI) transmitted on a physical downlink control channel (PDCCH), uplink control information (UCI) transmitted on a physical uplink control channel (PUCCH), and sidelink control information (SCI) transmitted on a physical sidelink control channel (PSCCH), which are channels of the PHY layer 130. Similarly, in the present disclosure, ‘higher layer signaling’ may include L2 signaling transmitted through a MAC control element (CE), L3 signaling transmitted through RRC signaling, and the like.

In particular, for convenience of description, although omitted in FIG. 1 of the present disclosure, information that may be included in interfaces (e.g. F1, NG interfaces, etc.) between base stations or between base station components such as distributed units (DU) and central units (CU) may also be collectively referred to as higher layer signaling together with L2 signaling or L3 signaling.

In a communication system to which the 5G communication technology, etc. is applied, one or more of numerologies of Table 1 may be used in accordance with various purposes, such as inter-carrier interference (ICI) reduction according to frequency band characteristics, latency reduction according to service characteristics, and the like.

TABLE 1

| μ | Δf = 24 · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Table 1 is merely an example for the convenience of description, and exemplary embodiments of the numerologies used in the communication system may not be limited thereto. Each numerology μ may correspond to information of a subcarrier spacing (SCS) Δf and a cyclic prefix (CP). The terminal may identify a numerology μ and a CP value applied to a downlink bandwidth part (BWP) or an uplink BWP based on higher layer parameters such as subcarrierSpacing, cyclicPrefix, and/or the like.

FIG. 2 is a conceptual diagram illustrating an exemplary embodiment of time resources in which radio signals are transmitted in a communication system.

Referring to FIG. 2, time resources in which radio signals are transmitted in a communication system 200 may be represented with a frame 220 comprising one or more

$$( {N}_{slot}^{f r a m e} / {N}_{slot}^{subframe , μ} )$$

subframes, a subframe 220 comprising one or more

$$( {N}_{slot}^{subframe , μ} )$$

slots, and a slot 210 comprising 14

$$( {N}_{symb}^{slot} )$$

OFDM symbols. In this case, according to a configured numerology, as the values of

$${N}_{symb}^{slot} , {N}_{slot}^{subframe , μ} , and {N}_{slot}^{frame , μ} ,$$

values according to Table 2 below may be used in case of a normal CP, and values according to Table 3 below may be used in case of an extended CP. The OFDM symbols included within one slot may be classified into ‘downlink’, ‘flexible’, or ‘uplink’ by higher layer signaling or a combination of higher layer signaling and L1 signaling.

TABLE 2

| μ | ${N}_{s y m b}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 3

| μ | ${N}_{s y m b}^{slot}$ | ${N}_{slot}^{frame , μ}$ | ${N}_{slot}^{subframe , μ}$ |
|---|---|---|---|
| 2 | 12 | 40 | 4 |

In the 5G NR communication system, the frame 230 may have a length of 10 ms, and the subframe 220 may have a length of 1 ms. Each frame 230 may be divided into two half-frames having the same length, and the first half-frame (i.e. half-frame 0) may be composed of subframes #0 to #4, and the second half-frame (i.e. half-frame 1) may be composed of subframes #5 to #9. One carrier may include a set of frames for uplink (i.e. uplink frames) and a set of frames for downlink (i.e. downlink frames).

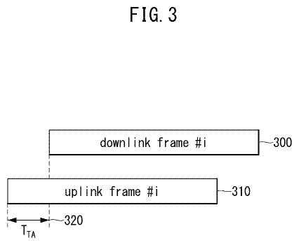

FIG. 3 is a conceptual diagram illustrating a time difference between a reception timing of an i-th downlink frame and a transmission timing of an i-th uplink frame in an exemplary embodiment of a communication system.

Referring to FIG. 3, a time difference between a reception timing of an i-th downlink frame 300 and a transmission timing of an i-th uplink frame 310 may be a TTA 320. Accordingly, the terminal may start transmission of the uplink frame #i 310 at a time earlier by TTA compared to the reception timing of the downlink frame #i 300. TTA may be referred to as a timing advance or timing adjustment TA. The base station may instruct the terminal to change a value of TTA through higher layer signaling or L1 signaling, and may configure the terminal to apply TTA in a manner defined as T_{TA}=(N_{TA}+N_{TA,offset})T_{c}. In the case of 5G NR, T_{c} may be defined as

$${T}_{c} = \frac{1}{( Δ {f}_{max} \cdot {N}_{f} )} ,$$

Δfₘₐₓ may be defined as Δfₘₐₓ=480 kHz, N_{f} may be defined as N_{f}=4096, N_{TA,offset} may be a value set by L3 signaling, and N_{TA} may be a value determined by Equation 1 below by a value TA indicated by L2 signaling.

### [Equation 1]

$${N}_{TA} = \{ \begin{matrix}{T}_{A} \cdot 16 \cdot \frac{64}{{2}^{μ}} ( for random access response ) \\ {N}_{TA\_old} + ( ( {T}_{A} - 31 ) \cdot 16 \cdot 64 / {2}^{μ} ) ( for other cases )\end{matrix}$$

Here, the description on N_{TA,offset} and N_{TA} may be an example for a specific situation, and various other options may exist, but in order not to obscure the gist of the description, all possible cases may not be listed in the present disclosure.

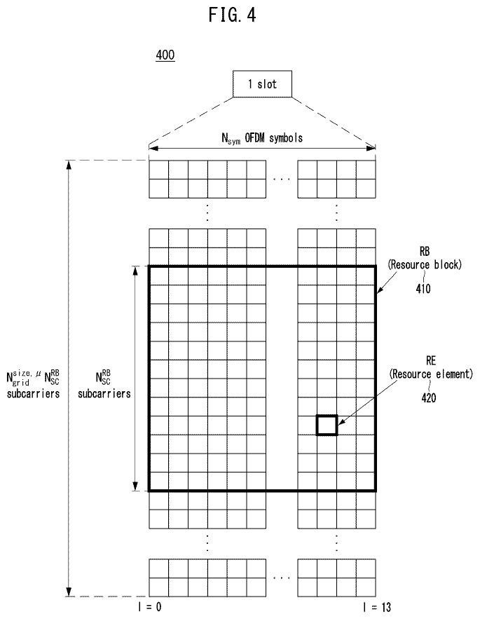

FIG. 4 is a conceptual diagram illustrating an exemplary embodiment of a time/frequency resource grid of a communication system.

Referring to FIG. 4, a time/frequency resource grid 400 of a communication system may have

$${N}_{grid}^{size , μ} {N}_{sc}^{RB} subcarriers and {N}_{slot}^{subframe , μ}$$

OFDMs. The resource grid may be defined for each numerology and each carrier. In this case,

$${N}_{grid}^{start , μ}$$

may mean a position of a common resource block (CRB) indicated by higher layer signaling.

$${N}_{grid}^{size , μ}$$

may mean the number of resource blocks (RBs) starting from the CRB, that is, a carrier bandwidth.

$${N}_{grid}^{start , μ} and / or {N}_{grid}^{size , μ}$$

may have different values for each link direction (e.g. uplink, downlink, or sidelink) or for each numerology μ. Here, the numerology μ may be referred to by other terms, such as a SCS configuration, if necessary.

Each element in the resource grid for an antenna port p and a SCS configuration μ may be referred to as a resource element (RE) 420, and may be uniquely defined for each position (k, l)_{p,μ}. In this case, k may be a frequency axis index, and l may indicate a symbol position on the time axis. RE(k, l)_{p,μ} may correspond to a physical resource used to transmit a physical channel or signal complex value

$${a}_{k , l}^{( p , μ )} .$$

One RB 410 may be defined as consecutive

$${N}_{sc}^{RB} = 12$$

subcarriers on the frequency axis.

The 5G NR communication system has introduced the concept of BWPs in order to reduce high implementation complexity and power consumption of terminals due to the widened carrier bandwidth compared to the 3G/4G communication system. One BWP may be composed of contiguous CRBs, a starting RB position

$${N}_{BWP , i}^{start , μ}$$

of the BWP and the number

$${N}_{BWP , i}^{size , μ}$$

of KBs constituting the BWP may satisfy Equations 2 and 3.

$${N}_{grid , x}^{start , μ} \leq {N}_{BWP , i}^{start , μ} < {N}_{grid , x}^{start , μ} + {N}_{grid , x}^{size , μ} \qquad [ Equation 2 ]$$

$${N}_{grid , x}^{start , μ} < {N}_{BWP , i}^{start , μ} + {N}_{BWP , i}^{size , μ} \leq {N}_{grid , x}^{start , μ} + {N}_{grid , x}^{size , μ} \qquad [ Equation 3 ]$$

Up to four downlink BWPs within one component carrier (CC) may be configured for one terminal, and only one downlink BWP may be activated at a time. The terminal may not receive a physical downlink shared channel (PDSCH), a physical downlink control channel (PDCCH), a channel state information reference signal (CSI-RS), or the like outside the activated BWP.

Up to four uplink BWPs within one CC may be configured for one terminal, and only one uplink BWP may be activated at a time. The terminal may not transmit a physical uplink shared channel (PUSCH), a physical uplink control channel (PUCCH), a sounding reference signal (SRS), or the like outside the activated BWP.

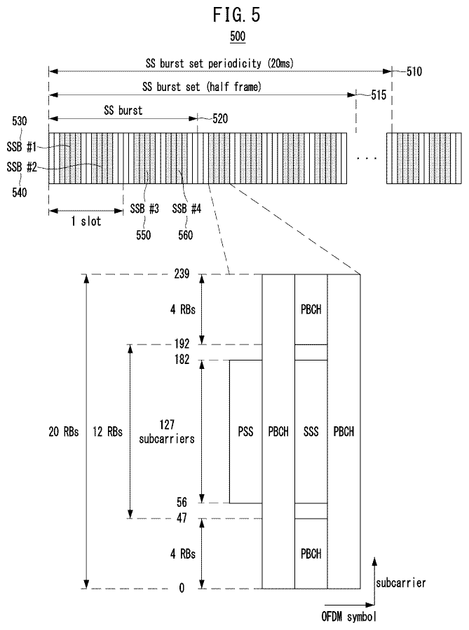

FIG. 5 is a conceptual diagram illustrating an exemplary embodiment of a synchronization signal and physical broadcast channel (SS/PBCH) block of a communication system.

Referring to FIG. 5, an SS/PBCH block 500 of a communication system may be configured with a primary synchronization signal (PSS) transmitted in 127 subcarriers in the middle of a first OFDM symbol, a secondary synchronization signal (SSS) transmitted in 127 subcarriers in the middle of a third OFDM symbol, and a physical broadcast channel (PBCH) transmitted in second, third, and fourth OFDM symbols. The PBCH occupying the widest bandwidth may be transmitted over 20 RBs, which may be 3.6 MHz based on 15 kHz SCS. The base station transmits one SSB by applying the same beam. When the number of base station antennas increases or it is necessary to operate multiple beams such as applying one or more analog beams for high frequency support, the base station may support a multi-beam operation by transmitting multiple SSBs. Here, the term ‘beam’ may be expressed in various terms such as a transmission precoding or a spatial transmission (TX) filter when applied in practice. However, in order not to obscure the gist of the description, ‘beam’ is used hereinafter as a unified term.

For example, the base station may transmit a plurality of SSBs 530, 540, 550, and 560 to represent a plurality of beams (e.g. beam #1, beam #2, beam #3, beam #4). In this case, it may be possible that one or more SSBs are transmitted within one slot according to a pattern predetermined according to each numerology. The SSBs 530, 540, 550, and 560 to which different beams are applied may be bundled into one set by being included in an SS burst 520. The terminal may assume a half-frame window having a length of 5 ms at the time of monitoring SSBs. An SS burst set 515 configured by higher layer signaling within a half-frame may include one or more SS bursts 520. If RRC configuration values are unknown or unavailable when performing initial access (IA), the terminal may receive or measure the SSBs assuming that a periodicity of the SS burst set 510 is 20 ms. As an example, the terminal may receive SSB(s) with reference to SSB configuration information identical or similar to that shown in Table 4 and Table 5.

TABLE 4

| | |
|---|---|
| MIB ::= | SEQUENCE { |
| systemFrameNumber | |
| subCarrierSpacingCommon | |
| ssb-SubcarrierOffset | // SSB subcarrier offset (0~15) |
| dmrs-TypeA-Position | |
| pdcch-ConfigSIB1 | |
| cellBarred | |
| intraFreqReselection | |
| spare | |
| } | |
| MeasObjectNR ::= | SEQUENCE { |
| ssbFrequency | // Absolute Radio Frequency Channel Number (ARFCN) of SSB |
| ssbSubcarrierSpacing | // Numerology of SSB |
| smtc1 | |

// first SSB measurement timing configuration (SMTC) configured with reference to SSB-

MTC

smtc2 // Second SMTC configured with reference to SSB-MTC

| | |
|---|---|
| } | |
| SSB-Index | // SSB |
| | index within SS-burst |

TABLE 5

```
SSB-MTC ::= SEQUENCE {
// timing occasion configuration for SSBs to be measured by terminal
periodicityAndOffset CHOICE {
    sf5 // offset when a SSB reception window has a legnth of 5 subframes
    sf10 // offset when a SSB reception window has a legnth of 10 subframes
    sf20 // offset when a SSB reception window has a legnth of 20 subframes
    sf40 // offset when a SSB reception window has a legnth of 40 subframes
    sf80 // offset when a SSB reception window has a legnth of 80 subframes
    sf160 // offset when a SSB reception window has a legnth of 160 subframes
  },
  duration // a lengh of a SSB recepion window (number of subframes)
}
SSB-MTC2 ::= SEQUENCE {
  pci-List // physical cell IDs (PCIs) following the SMTC configuration
    periodicity // SMTC periodicity (number of subframes)
}
```

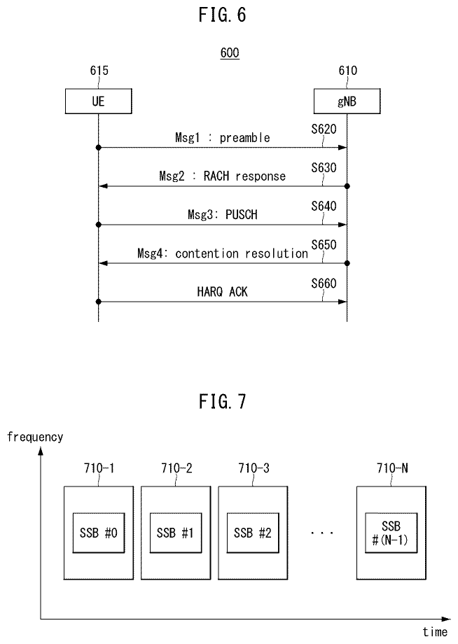

FIG. 6 is a sequence chart illustrating an exemplary embodiment of a random access procedure in a communication system.

Referring to FIG. 6, in a random access procedure of a communication system 600, a terminal 615 may transmit a physical random access channel (PRACH) preamble, and the PRACH preamble may be referred to as ‘Msg1’ (S620). Through a transmission of the PRACH preamble, random access-radio network temporary identifier (RA-RNTI) may be determined. In this case, the RA-RNTI may be calculated by Equation 4.

$$RA - RNTI = 1 + {s}_{id} + 14 \times {t}_{id} + 14 \times 80 \times {f}_{id} + 14 \times 80 \times 8 \times {ul}_{{carrier}_{id}} \qquad [ Equation 4 ]$$

In Equation 4, s_{id} may be an index of a first OFDM symbol of a corresponding PRACH occasion (e.g., 0≤s_{id}<14), t_{id} may be an index of a first slot of the PRACH occasion within a system frame (e.g. 0≤f_{id}<80), f_{id} may be an index of the PRACH occasion in the time domain (e.g. 0≤f_{id}<8), and ul_{carrier}_{_{id}} may be a value according to a uplink carrier type used for the preamble transmission (e.g. 0 indicates a regular uplink carrier, 1 indicates a supplementary uplink carrier).

Before the terminal transmits the PRACH preamble, the terminal may have at least part of the following information by receiving system information from the base station on a PBCH or receiving RRC signaling from the base station.
PRACH preamble format
Time/frequency resource information for RACH transmission
Index for a logical root sequence table
Cyclic shift N_{CS}
Set type (unrestricted, restricted set A, restricted set B)

Referring again to FIG. 6, as a second procedure, the base station may provide a random access response (RAR) to the terminal, which may be referred to as ‘Msg2’ (S630). Particularly, the base station may calculate an RA-RNTI based on Equation 4 when the base station receives the PRACH preamble from the terminal in the step S620, and may transmit a DCI by using the RA-RNTI for scrambling. The terminal may monitor a PDCCH scrambled with the RA-RNTI in a period included in a RACH response window configured by the higher layer in a type 1 PDCCH common search space (CSS). The terminal may receive the PDCCH (or the DCI transmitted from the base station through the PDCCH), and may decode the PDCCH (or the DCI). If the terminal successfully decodes the PDCCH (or the DCI), the terminal may decode a PDSCH including the RAR transmitted from the base station in the step S630. If the terminal succeeds in decoding the RAR, the terminal may identify whether an RA preamble identifier (RAPID) in the RAR matches a RAPID pre-allocated to the terminal.

As a third procedure, the terminal may transmit a PUSCH to the base station, which may be referred to as ‘Msg3’ (S640). To this end, the terminal may determine whether to apply a transform precoding to transmission of the PUSCH (i.e. whether to apply discrete Fourier transform (DFT)-s-OFDM-based transmission or OFDM-based transmission) based on a higher layer parameter (e.g. msg3-transformPrecoding). Also, the terminal may determine a SCS to be used for transmission of the PUSCH according to a higher layer parameter (e.g. msg3-scs). In this case, the PUSCH of Msg3 may be transmitted through a serving cell to which the PRACH has been transmitted.

As a fourth procedure, the base station may transmit a contention resolution message to the terminal, which may be referred to as ‘Msg4’ (S650). The terminal may start a timer for receiving the contention resolution message, and may monitor a PDCCH scrambled with a temporary cell-RNTI (TC-RNTI) in the type 1 PDCCH CSS until the timer expires. If the terminal successfully decodes the PDCCH, the terminal may decode a corresponding PDSCH including a MAC CE, and set the TC-RNTI as a cell-RNTI (C-RNTI). After successfully decoding the Msg4, the terminal may report a hybrid automatic repeat request (HARQ) positive-acknowledgement (ACK) thereto to the base station, and may report whether the RACH procedure is successful to the base station (S660).

The RACH occasion (RO) may mean a time and frequency resource specified for reception of a RACH preamble, and the terminal may use the RO for PRACH transmission. As described above, in the 5G NR, multiple SSBs may be associated with different beams for the multi-beam operation, and the terminal may measure the multiple SSBs, and select an optimal SSB (i.e. optimal beam) based on one of various schemes such as a reference signal received power (RSRP), reference signal received quality (RSRQ), signal-to-noise ratio (SNR), signal-to-noise/interference ratio (SNIR), or the like. Thereafter, the terminal may determine a beam (i.e. TX spatial filter) to be used for PRACH transmission based on the beam (i.e. RX spatial filter) used when receiving the optimal SSB. In this case, a relationship between SSB(s) and RO(s) may be established for the purpose of allowing the base station or the network to know which SSB (i.e. beam) the terminal has selected. Through such the relationship, the base station may know the SSB (i.e. beam) selected by the terminal based on the RO in which the terminal has transmitted the PRACH. For example, the relationship between SSB(s) and RO(s) may be determined with reference to the higher layer configurations identical or similar to those shown in Table 6 and Table 7.

TABLE 6

```
RACH-ConfigCommon ::= SEQUENCE {
  rach-ConfigGeneric // set of RACH parameters
  totalNumberOfRA-Preambles // the total number of RACH preambles (1~63)
  ssb-perRACH-OccasionAndCB-PreamblesPerSSB CHOICE {
    oneEighth // The number of preambles per SSB when one SSB is associated with eight ROs
    oneFourth // The number of preambles per SSB when one SSB is associated with four ROs
    oneHalf // The number of preambles per SSB when one SSB is associated with two ROs
    one // The number of preambles per SSB when one SSB is associated with one RO
    two // The number of preambles per SSB when two SSBs are associated with one RO
    four // The number of preambles per SSB when four SSBs are associated with one RO
eight // The number of preambles per SSB when eigth SSBs are associated with one RO
sixteen // The number of preambles per SSB when sixteen SSBs are associated with one RO
}
  groupBconfigured SEQUENCE {
    ra-Msg3SizeGroupA // The size of a transport block fro contention-based RA of Group A
    messagePowerOffsetGroupB // Threshold for preamble selection
    numberOfRA-PreamblesGroupA // The number of CB preambles per SSB of Group A
}
```

TABLE 7

```
  ra-ContentionResolutionTimer // Initial value of a contention resolution timer
  rsrp-ThresholdSSB // Threshold for selection of an SSB and an associated RACH resource
  rsrp-ThresholdSSB-SUL // Threshold for selection of an SSB and an associated RACH resource
in SUL
  prach-RootSequenceIndex CHOICE { // RACH root sequence index
    1839
    1139
  },
  msg1-SubcarrierSpacing  // SCS for Msg1 transmission
  restrictedSetConfig  // one of {unrestricted, restricted set A, restricted set B}
  msg3-transformPrecoder  // whether to apply transform precoding in transmisison of Msg3
  ...
}
RACH-ConfigGeneric ::= SEQUENCE {
  prach-ConfigurationIndex  // indicates a preamble format, etc.
  msg1-FDM  // The number of ROs FDMed at a time
  msg1-FrequencyStart // frequnency-axis offset of the lowest RO with reference to PRB 0
zeroCorrelationZoneConfig // N-CS configuration
  preambleReceivedTargetPower // Target power level at a network receiving node
preambleTransMax
// The maximum number of RA preambe transmissions performed unitl declaration of an RA failure
    powerRampingStep // Power ramping step
  ra-ResponseWindow // Msg2 (RAR) window length (number of slots)
  ...,
}
```

FIG. 7 is a conceptual diagram illustrating a first exemplary embodiment of SSB-RO association according to RACH configuration in a communication system.

Referring to FIG. 7, in an SSB-RO mapping relation according to the RACH configurations, in a certain frequency band, N SSBs 710-1 to 710-n having time resources which are separated from each other may be mapped to ROs 720-1 to 720-n having time resources which are separated from each other on a one-to-one basis. For example, if a higher layer parameter msg1-FDM is set to 1 (i.e. msg1-FDM=one) and a higher layer parameter ssb-perRACH-OccasionAndCB-PreamblesPerSSB is set to 1 (e.g. ssb-perRACH-OccasionAndCB-PreamblesPerSSB=one), the N different SSBs 710-1 to 710-n may be mapped to the N different ROs 720-1 to 720-n on a one-to-one basis.

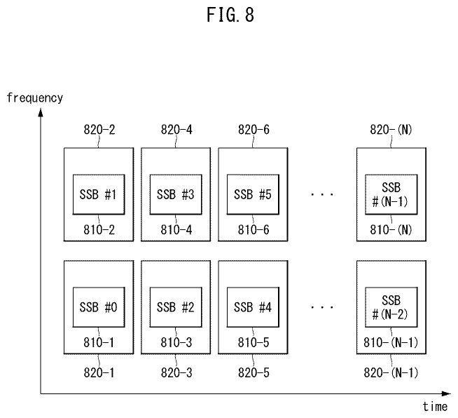

FIG. 8 is a conceptual diagram illustrating a second exemplary embodiment of SSB-RO association according to RACH configuration in a communication system.

Referring to FIG. 8, in an SSB-RO mapping relation according to the RACH configurations, in a first frequency band, SSBs 810-1, 810-3, 810-5, . . . , and 810-(n−1) having time resources which are separated from each other may be mapped to ROs 820-1, 820-3, 820-5, . . . , and 820-(n−1) having time resources which are separated from each other on a one-to-one basis. In addition, in a second frequency band, SSBs 810-2, 810-4, 810-6, . . . , and 810-n having time resources which are separated from each other may be mapped to ROs 820-2, 820-4, 820-6, . . . , and 820-n) having time resources which are separated from each other on a one-to-one basis. For example, if the higher layer parameter msg1-FDM is set to 2 (i.e. msg1-FDM=two), and higher layer parameter ssb-perRACH-OccasionAndCB-PreamblesPerSSB is set to 2 (e.g. ssb-perRACH-OccasionAndCB-PreamblesPerSSB-two), the N different SSBs 810-1 to 810-n may be mapped to the N different ROs 820-1 to 820-n which are frequency division multiplexed (FDMed) in a frequency domain, on a one-to-one basis.

Meanwhile, the 5G NR communication system may support DCI formats shown in Table 8 based on Release-16.

TABLE 8

| DCI format | Usage |
|---|---|
| 0_0 | Used for scheduling a PUSCH within one cell |
| 0_1 | Used for scheduling one or more PUSCHs within one cell, or indicating downlink |
| | feedback information for a configured grant (CG) PUSCH (i.e. CG-DFI) |
| 0_2 | Used for scheduling a PUSCH within one cell |
| 1_0 | Used for scheduling a PDSCH within one cell |
| 1_1 | Used for scheduling a PDSCH within one cell or triggering a one-shot HARQ-ACK |
| | codebook feedback |
| 1_2 | Used for scheduling a PDSCH within one cell |
| 2_0 | Used for notifying a slot format, an available RB set, a channel occupancy time |
| | (COT) duration, and search space set group switching to a UE group |
| 2_1 | Used for notifying PRB(s) and OFDM symbol(s) assumed not to be intended to be |
| | used for transmission to a UE group |
| 2_2 | Used for transmission of a transmission power control (TPC) for a PUCCH and a |
| | PUSCH |
| 2_3 | Used for transmission of a TPC command group for SRS transmission by one or more |
| | UEs |
| 2_4 | Used for a UE to notify PRB(s) and OFDM symbol(s) for which UL transmission |
| | from the UE is cancelled to a UE group |
| 2_5 | Used for notifying availability of soft resources |
| 2_6 | Used for notifying power saving information outside a DRX active time to one or |
| | more UEs |
| 3_0 | Used for NR sidelink scheduling within one cell |
| 3_1 | Used for LTE sidelink scheduling within one cell |

DCI may include downlink control information for one or more cells, and may be associated with one RNTI. The DCI may be encoded through the order of 1) information element multiplexing, 2) cyclic redundancy check (CRC) addition, 3) channel coding, and 4) rate matching, and decoding may also be performed in consideration of the above steps. In the above description, “a certain DCI is associated with one RNTI” may mean that CRC parity bits of the DCI are scrambled with the RNTI. Referring to Table 8, some DCI may include scheduling information of one or more PUSCHs for a certain cell.

For example, a CRC of the DCI format 0_1 may be scrambled with a C-RNTI, configured scheduling-RNTI (CS-RNTI), semi-persistent CSI RNTI (SP-CSI-RNTI), or modulation coding scheme cell RNTI (MCS-C-RNTI). The DCI format 0_1 may include at least one of the following information.
Identifier for DCI format (1 bit): Indicator indicating a UL DCI format, which is always set to 0 in the case of DCI format 0_1
Carrier indicator (0 or 3 bits): Indicator indicating a CC scheduled by the corresponding DCI
DFI flag (0 or 1 bit): Configured grant downlink feedback information (CG-DFI) indicator
If the DCI format 0_1 is used for CG-DFI indication (when the DFI flag is set to 1), at least one of the following fields may be used:
HARQ-ACK bitmap (16 bits), where the order of mapping HARQ process indexes within the bitmap is that the HARQ process indexes are mapped from the MSB to the LSB of the bitmap in ascending order. For each bit in the bitmap, a value of 1 indicates ACK, and a value of 0 indicates NACK.
TPC command for a scheduled PUSCH (2 bits)
All the remaining bits in the DCI format 0_1 are set to zero
If the DCI format 0_1 is not used for CG-DFI indication (when there is no DFI flag field or DFI flag field is set to 0), at least one of the following fields may be used:
UL/SUL indicator (0 or 1 bit): supplementary UL indicator.
Bandwidth part indicator (0, 1, or 2 bits): Indicator indicating a BWP to be activated among uplink BWPs configured for the terminal.
Frequency domain resource assignment: Indicator for allocating a frequency domain resource.
Time domain resource assignment: Indicator for allocating a time domain resource.
Frequency hopping flag (0 or 1 bit): Frequency axis hopping indicator
Modulation and coding scheme (5 bits)
New data indicator (NDI): Indicator indicating whether allocated data is new data or retransmission data.
Redundancy version (RV): Indicator indicating an RV value when channel coding is applied to allocated data
HARQ process number (4 bits): Indicator indicating a HARQ process to be allocated to scheduled data
TPC command for a scheduled PUSCH (2 bits): TPC indicator
SRS resource indicator: Aperiodic SRS resource selection indicator
Precoding information and number of layers: Indicator indicating precoding and the number of transport layers to be used in PUSCH transmission
Antenna ports: Indicator for uplink antenna ports to be used for PUSCH transmission
SRS request: Indicator indicating whether to transmit aperiodic SRS
CSI request: Indicator indicating whether and how to report channel state information
PTRS-DMRS association: Indicator indicating a relationship between an uplink phase-noise tracking reference signal (PTRS) antenna port and a demodulation reference signal (DMRS) antenna port
DMRS sequence initialization: Indicator for a DMRS sequence initialization value during OFDM-based uplink transmission
UL-SCH indicator: Indicator indicating whether or not an uplink shared channel (UL-SCH) is included in a PUSCH (a PUSCH that does not include a UL-SCH needs to include CSI)
Open-loop power control parameter set indication: Indicator indicating a set of open-loop power control (OPLC) parameter set
Priority indicator: Uplink transmission priority indicator
Invalid symbol pattern indicator: Indicator indicating whether to apply an invalid symbol pattern configured by a higher layer

As another example, a CRC of the DCI format 1_1 may be scrambled with a C-RNTI, CS-RNTI, or MCS-C-RNTI, and the DCI format 1_1 may include at least one of the following information.
Identifier for DCI format (1 bit): Indicator indicating a DL DCI format, which is always set to 1 in the case of DCI format 1_1
Carrier indicator (0 or 3 bits): Indicator indicating a CC scheduled by the corresponding DCI
Bandwidth part indicator (0, 1, or 2 bits): Indicator indicating a BWP to be activated among downlink BWPs configured for the terminal
Frequency domain resource assignment: Indicator for allocating a frequency domain resource
Time domain resource assignment: Indicator for allocating a time domain resource
PRB bundling size indicator: Indicator indicating a type (i.e. static or dynamic) and a size of PRB bundling
Rate matching indicator: Indicator indicating a rate matching pattern configured by a higher layer
ZP CSI-RS trigger: Indicator for applying aperiodic zero-power (ZP) CSI-RS
‘modulation and coding scheme’, ‘new data indicator’, and ‘redundancy version’ fields for a transport block 1
‘modulation and coding scheme’, ‘new data indicator’, and ‘redundancy version’ fields for a transport block 2
HARQ process number: Indicator indicating a HARQ process to be allocated to scheduled data
Downlink assignment index: DAI indicator for HARQ-ACK codebook generation in TDD operation
TPC command for a scheduled PUCCH: Power control indicator for PUCCH transmission
PUCCH resource indicator: Indicator indicating a PUCCH resource for transmitting HARQ-ACK information for an allocated PDSCH or a predetermined PDSCH set
PDSCH-to-HARQ_feedback timing indicator: Indicator indicating a time axis offset between the allocated PDSCH and the PUCCH
Antenna port(s): Indicator indicating antenna ports to be used for PDSCH transmission/reception
Transmission configuration indication: Indicator indicating transmission configuration information (TCI) to be used for PDSCH transmission and reception
SRS request: Indicator indicating whether to transmit aperiodic SRS
DMRS sequence initialization: Indicator for a DMRS sequence initialization value used for PDSCH transmission and reception
Priority indicator: PDSCH reception priority indicator

As another example, certain DCI formats may be used to deliver the same control information to one or more terminals. For example, a CRC of the DCI format 2_3 may be scrambled with a transmit power control-sounding reference signal-RNTI (TPC-SRS-RNTI), and may include at least one of the following information.
Block number 1, Block number 2, . . . , Block number B: Indicators indicating resource regions to which the DCI format 2_3 is applied. A starting part of the block is configured by a higher layer parameter starting BitOfFormat2-3 or startingBitOfFormat2-3SUL-v1530.
When a terminal for which a higher layer parameter srs-TPC-PDCCH-Group is set to type A performs uplink transmission without a PUCCH and PUSCH or uplink transmission in which SRS power control is not tied to PUSCH power control, one block is configured by the higher layer, and the following fields are defined for the block.
SRS request (0 or 2 bits): Aperiodic SRS transmission indicator
TPC command number 1, TPC command number 2, . . . , TPC command number N: Indicators indicating uplink power control to be applied to a UL carrier indicated by a higher layer parameter cc-IndexInOneCC-Set.
When a terminal for which a higher layer parameter srs-TPC-PDCCH-Group is set to type B performs uplink transmission without a PUCCH and PUSCH or uplink transmission in which SRS power control is not tied to PUSCH power control, one or more blocks may be configured by the higher layer, and the following fields are defined for each block.
SRS request (0 or 2 bits): Aperiodic SRS transmission indicator.
TPC command (2 bits)

As another example, certain DCI formats may be used to deliver the same control information to more than one terminal. For example, a CRC of a DCI format 2_0 may be scrambled with an SFI-RNTI and may be used to notify information such as slot format(s), channel occupancy time (COT) duration(s), available RB set(s), and search space set group switching. Specifically, the DCI format 2_0 may include at least one of the following information.
If a higher layer parameter slotFormatCombToAddModList is configured,
   Slot format indicator 1, Slot format indicator 2, . . . , Slot format indicator N
If a higher layer parameter availableRB-SetsToAddModList-r16 is configured,
   Available RB set indicator 1, Available RB set indicator 2, . . . , Available RB set indicator N1
If a higher layer parameter co-DurationsPerCellToAddModList-r16 is configured,
   COT duration indicator 1, COT duration indicator 2, . . . , COT duration indicator N2
If a higher layer parameter searchSpaceSwitchTriggerToAddModList-r16 is configured,
   Search space set group switching flag 1, Search space set group switching flag 2, . . . , Search space set group switching flag M

The size of DCI format 2_0 may be set by a higher layer as one of values up to 128 bits. For example, a DCI format 2_5 may be used to notify availability of soft type resources of an IAB node. A CRC of the DCI format 2_5 may be scrambled with an availability indicator (AI)-RNTI and may include information below.
Availability indicator 1, Availability indicator, . . . , Availability indicator N

The size of DCI format 2_5 may set by a higher layer as one of values less than or equal to 128 bits.

The terminal may receive configuration information of a CORESET #0 and a search space #0, identical or similar to that shown in Table 9.

TABLE 9

```
PDCCH-ConfigSIB1 ::= SEQUENCE {
        controlResourceSetZero
        searchSpaceZero
}
ControlResourceSetZero // indicates a configuration value (0~15) of a CORESET #0 within an
initial BWP
SearchSpaceZero // indicates a configuration value (0~15) of a search space #0 within an initial
BWP
```

The terminal may refer to the following higher layer configurations for cell-specific PDCCH monitoring, identical or similar to those shown in Tables 10 to 13.

TABLE 10

```
PDCCH-ConfigCommon ::= SEQUENCE {
  controlResourceSetZero // indicates a configuration value (0~15) of a CORESET #0 within an
initial BWP
  commonControlResourceSet
      // configure a common CORESET by referring to CORESET configuration
searchSpaceZero  // indicates a configuration value (0~15) of a search space #0 within an initial
BWP
  commonSearchSpaceList // configures a search sapce to be used for cell-specific PDCCH
monitoring by referring to up to four search space configurations
searchSpaceSIB1 // search space configuration for SIB1
searchSpaceOtherSystemInformation // search space configuration for SIB2 or other SIBs
pagingSearchSpace // search space configuration for paging
  ra-SearchSpace // search space configuration for random access procedure
  ...
}
```

TABLE 11

```
ControlResourceSet ::= SEQUENCE {
  controlResourceSetId // CORESET ID (a value other than 0 is used)
frequencyDomainResources // configuration of frequency resources of a CORESET
  duration // configuration of a time-axis length (symbols) of a CORESET
cce-REG-MappingType CHOICE { // CCE-to-REG mapping configuration
    interleaved SEQUENCE {
      reg-BundleSize
      interleaverSize
      shiftIndex
    },
    nonInterleaved
  },
  precoderGranularity
  tci-StatesPDCCH-ToAddList
// indicates a QCL relation possible between a QCL reference RS and a PDCCH DMRS
tci-StatesPDCCH-ToReleaseList
  tci-PresentInDCI // indicates whether a TCI field exists within the DCI format 1_1
pdcch-DMRS-ScramblingID // indicates a scrambling initialization value of a PDCCH DMRS
...
}
```

TABLE 12

```
SearchSpace ::= SEQUENCE {
  searchSpaceId // search space ID
  controlResourceSetId // CORESET ID associated with the search space
monitoringSlotPeriodicityAndOffset CHOICE { // periodicity and offset of a PDCCH monitoring
slot
s11 // performs PDCCH monitoring in every slot
...
// (omitted) monitoring offset values when a PDCCH monitoring periodicity is one of 2 to 1280 slots
    s12560 // a monitoring offset value when a PDCCH monitoring periodicity is 2560 slots
  }
  duration // the number of slots where a search space exists for each occasion

[symbol]

  monitoringSymbolsWithinSlot
// a position of a first symbol on which monitoring is to be performed within a PDCCH monitoring
slot
nrofCandidates SEQUENCE {
      aggregationLevel1 // The number of PDCCH candidates in case of aggregation level 1
aggregationLevel2 // The number of PDCCH candidates in case of aggregation level 2
      aggregationLevel4 // The number of PDCCH candidates in case of aggregation level 4
      aggregationLevel8 // The number of PDCCH candidates in case of aggregation level 8
      aggregationLevel16 // The number of PDCCH candidates in case of aggregation level 16
  }
  searchSpaceType CHOICE { // indicates a search space type (common or UE-
specific) and DCI formats
```

TABLE 13

```
    common SEQUENCE {
      dci-Format0-0-AndFormat1-0 SEQUENCE {
        ...
      }
      dci-Format2-0 SEQUENCE {
        nrofCandidates-SFI SEQUENCE {
          ...
        },
        ...
      }
      dci-Format2-1
      dci-Format2-2
      dci-Format2-3 SEQUENCE {
        dummy1
        dummy2
      }
    },
    ue-Specific SEQUENCE {
      dci-Formats
      ...,
    }
  }
}
```

The terminal may refer to the following higher layer configurations for UE-specific PDCCH monitoring, identical or similar to those shown in Table 14.

TABLE 14

```
PDCCH-Config ::= SEQUENCE {
  controlResourceSetToAddModList
// At most three CORESETs are configured by referring to CORESET configuration
controlResourceSetToReleaseList
  searchSpaces ToAddModList
// At most ten search spaces are configured by referring to search space configuration
searchSpacesToReleaseList
  downlinkPreemption  // downlink preemption indicator
tpc-PUSCH // configuraion of reception of a group TPC for PUSCH transmission
tpc-PUCCH // configuration of reception of a group TPC for PUCCH transmission
tpc-SRS // configuration of reception of a group TPC for SRS transmission
...,
}
```

The presence of one antenna port may mean a case in which a channel experienced by a symbol transmitted through the corresponding antenna port can be estimated or inferred from a channel experienced by another symbol transmitted through the same antenna port.

“Two different antenna ports are quasi co-located (QCLed)” may mean a case in which large-scale characteristics of a channel experienced by a symbol transmitted through one antenna port can be estimated or inferred from a channel experienced by a symbol transmitted through another antenna port. The large-scale characteristics of the channel may mean at least one of ‘delay spread’, ‘Doppler spread’, ‘Doppler shift’, ‘average gain’, ‘average delay’, and ‘spatial Rx parameters’.

When time/frequency resources of a certain signal (e.g. QCL target RS) are insufficient and large-scale characteristics of a channel cannot be accurately measured with only the corresponding signal, information (i.e. QCL information) on another signal (e.g. QCL reference RS having sufficient time/frequency resources) having large-scale characteristics that can be reused for reception of the corresponding signal (i.e. QCL target RS) may be provided to the terminal to improve the channel measurement performance of the terminal. The NR communication system may support various QCL types as follows.
QCL-Type A: including {Doppler shift, Doppler spread, average delay, delay spread}.
QCL-Type B: including {Doppler shift, Doppler spread}
QCL-Type C: including {Doppler shift, average delay}
QCL-Type D: including {Spatial Rx parameters}

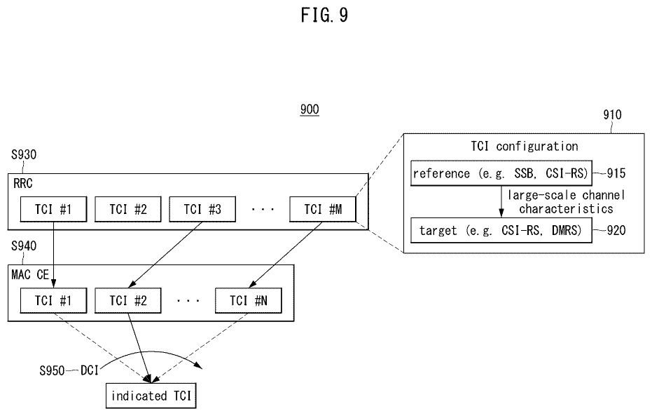

FIG. 9 is a conceptual diagram illustrating an exemplary embodiment of a QCL information transfer process through TCI state configuration and indication in a communication system.

Referring to FIG. 9, in a process of transmitting QCL information through TCI state configuration and indication in a communication system 900, a base station may configure at most M TCI states to a terminal through higher layer (i.e. RRC) signaling, in accordance with a UE capability report and a maximum value (e.g. 4, 8, 64, or 128 depending on a frequency band) defined in a technical specification (S930). In this case, each TCI state configuration 910 may include information on a signal or channel (i.e. QCL reference 915) that provides large-scale channel characteristics to a signal or channel (i.e. QCL target 920) referring to the TCI. One TCI state configuration 910 may include up to two references (i.e. qcl-Type1 and qcl-Type2), the first reference may be one of the QCL-Type A, QCL-Type B, and QCL-type C (i.e. qcl-type1={QCL-type A, QCL-type B, QCL-type C}), and the second reference may be the QCL-type D if present (i.e. qcl-type 2=QCL-type D).

Allowing the base station to apply all the TCIs configured through the RRC signaling in real time may greatly increase implementation complexity of the terminal, the base station may transmit an activation message for some of the TCIs configured through the RRC signaling to the terminal through L2 signaling such as a MAC CE (S940). The base station may activate a maximum of N (<M) TCIs, and the terminal may receive a dynamic indication only for the activated TCI.

Thereafter, the base station may dynamically indicate to the terminal some of the activated N TCIs through L1 signaling such as a DCI (S950). The terminal may apply QCL information indicated by the corresponding TCI at a predetermined timing after receiving the L1 signaling, and may perform a reception operation for the signal or channel.

The TCI state indication steps including the ‘RRC signaling (S930)’, ‘MAC CE signaling (S940)’, and ‘DCI signaling (S950)’ of FIG. 9 may be partially omitted depending on a type of the QCL target RS. For example, when the QCL target is a PDSCH DMRS, and one or more TCI states are configured through RRC signaling, the base station may indicate the TCI state using all the steps of FIG. 9. However, when the QCL target is a PDSCH DMRS, and a single TCI state is configured through RRC signaling, the MAC CE signaling (S940) and the DCI signaling step (S950) may be omitted. Similarly, when the QCL target is a PDCCH DMRS, the DCI signaling step S940 may be omitted. Specifically, the terminal may obtain configuration information for the TCI states and QCL information with reference to the RRC signaling identical or similar to those shown in Table 15.

TABLE 15

```
TCI-State ::= SEQUENCE { // TCI configuration (I.1-00)
  tci-StateId  // TCI state ID
  qcl-Type1  // first QCL reference configured by referring to QCL information
qcl-Type2 // second QCL reference configured by referring to QCL information
  ...
}
QCL-Info ::= SEQUENCE {
  cell // index of a cell in which QCL reference is transmitted
  bwp-Id // index of a BWP in which QCL reference is transmitted
referenceSignal CHOICE {
    csi-rs // index of a CSI-RS to be referred when QCL reference is a CSI-RS
ssb // index of an SSB to be referred when QCL reference is an SSB
  },
  qcl-Type
  // QCL type to be applied to a QCL target (one of QCL-type A, QCL-type B, QCL-type C, and
QCL-type D)
  ...
}
```

The base station may instruct the terminal to activate or deactivate some of the TCI states configured by the RRC signaling through MAC CE signaling, or may instruct the terminal to apply a TCI state indicated by a MAC CE to the QCL target RS. For example, the base station may use the following MAC CE signaling according to the type of the QCL target RS.
TCI state activation/deactivation MAC CE for a UE-specific PDSCH DMRS
TCI state indication MAC CE for a UE-specific PDCCH DMRS
TCI state activation/deactivation MAC CE for an enhanced UE-specific PDSCH DMRS

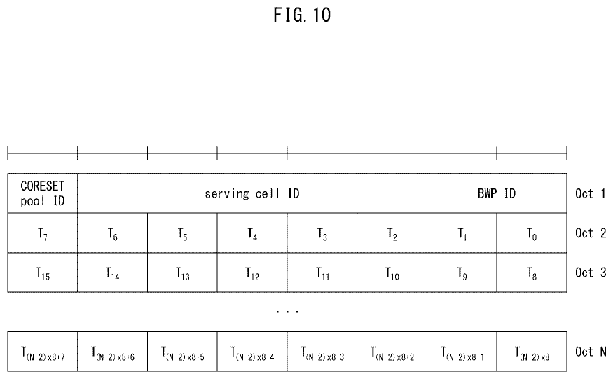

FIG. 10 is a conceptual diagram illustrating an exemplary embodiment of a TCI state activation/deactivation MAC CE in a communication system.

Referring to FIG. 10, a first octet (Oct 1) in a TCI state activation/deactivation MAC CE for a UE-specific PDSCH DMRS may include a COREST pool ID field 1010, a serving cell ID field 1020, and a BWP ID field 1030, and a second octet (Oct 2) to an N-th octet (Oct N) may include Ti fields 1040 indicating TCI state IDs i. The detailed meaning of each field may be as follows, and the sizes thereof may be variable.
Serving cell ID: a serving cell ID to which the MAC CE is applied
BWP ID: BWP ID to which the MAC CE is applied, which indicates a BWP in association with a BWP indication field within the DCI
Ti: indicates a TCI state ID i. When this value is set to 0, it may mean that a TCI state whose TCI state ID is i is deactivated, and when this value is set to 1, it may mean that a TCI state whose TCI state ID is i is activated. The TCI states activated by 1 may be sequentially mapped to TCI indication field code points within the DCI.
CORESET pool ID: If a DCI scheduling a PDSCH is monitored in a CORESET that does not include a higher layer parameter coresetPoolIndex, the field may be ignored. If a DCI scheduling a PDSCH is monitored in a CORESET including the higher layer parameter coresetPoolIndex, Ti indication may be applied only when a value of the CORESET pool ID matches a value of coresetPoolIndex of the CORESET.

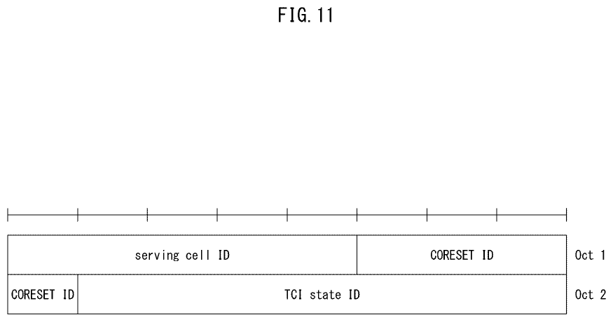

FIG. 11 is a conceptual diagram illustrating an exemplary embodiment of a TCI state indication MAC CE in a communication system.

Referring to FIG. 11, a first octet (Oct 1) in a TCI state activation/deactivation MAC CE for a UE-specific PDSCH DMRS may include a serving cell ID field 1110 and a CORESET ID field 1120, and a second octet (Oct 2) may include a CORESET ID field 1130 and a TCI state ID field 1140. The sizes thereof may be variable.
Serving cell ID: a serving cell ID to which the corresponding MAC CE is applied.
CORESET ID: indicates a CORESET to which the MAC CE is applied. If this value is set to 0, a CORESET configured through controlResourceSetZero may be a CORESET #0.
TCI state ID: means a TCI state ID indicated by the corresponding MAC CE.

The base station may configure spatial relation information to the terminal through higher layer (e.g. RRC) signaling in order to indicate uplink beam information. The spatial relation information may mean a signaling structure for using spatial domain filters used for transmission and reception of a reference RS for spatial TX filters for uplink transmission of a target RS according to the corresponding spatial relation. The spatial reference RS may be a downlink signal such as SSB or CSI-RS, and may also be an uplink signal such as SRS. If the reference RS is a downlink signal, the terminal may use the spatial RX filter values used for receiving the reference RS as spatial TX filter values for transmitting the target RS according to the spatial relation. If the reference RS is an uplink signal, the terminal may use the spatial TX filter values used for transmitting the reference RS as the spatial TX filter values for transmitting the target RS according to the spatial relation.

The signaling structure for the spatial relation information may vary depending on the type of target RS. For example, when the target RS is an SRS, the base station may perform RRC configuration for each SRS resource based on message identical or similar to those shown in Table 16.

TABLE 16

```
SRS-SpatialRelationInfo ::=  SEQUENCE {
  servingCellId // index of a serving cell in which a reference RS is transmitted
  referenceSignal CHOICE {
    ssb-Index // SSB index when a reference RS is SSB
    csi-RS-Index // CSI-RS resource index when a reference RS is CSI-RS
srs SEQUENCE {
            resourceId // SRS resource index when a reference RS is SRS
uplinkBWP // index of a UL BWP in which SRS is transmitted when a reference RS is SRS
}
  }
}
```

For example, when the target RS is an SRS, the base station may perform RRC configuration for each SRS resource, identical or similar to those shown in Table 17.

TABLE 17

```
PUCCH-SpatialRelationInfo ::= SEQUENCE {
  pucch-SpatialRelationInfoId // spatial relation information ID for PUCCH
  servingCellId // index of a serving cell in which a reference RS is transmitted
referenceSignal CHOICE {
    ssb-Index // SSB index when a reference RS is SSB
    csi-RS-Index // CSI-RS resource index when a reference RS is CSI-RS
    srs // specifiy a SRS resource by referring to PUCCH-SRS configuration
},
  pucch-PathlossReferenceRS-Id
// index of a RS resource to be used for measurement of a pathloss of a PUCCH
p0-PUCCH-Id // index of confuring p0 for PUCCH power control
closedLoopIndex // configuration value of closed-loop power control
}
PUCCH-SRS ::= SEQUENCE {
  resource // SRS resource index
  uplinkBWP // index of a BWP in which SRS is transmitted
}
```

In the 5G NR communication system, a slot format may include downlink symbol(s), uplink symbol(s), and/or flexible symbol(s).

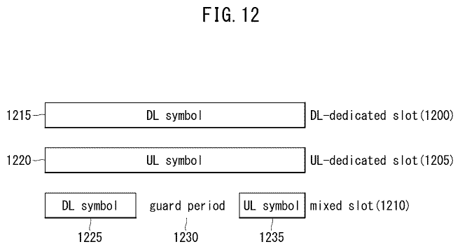

FIG. 12 is a conceptual diagram illustrating slot configurations according to slot formats in a communication system.

Referring to FIG. 12, in slot configurations according to slot formats in a communication system, a downlink dedicated slot 1200 may be a slot in which all symbols within the slot are configured only as downlink symbols 1215 according to a slot format. As another example, an uplink dedicated slot 1205 may be a slot in which all symbols within the slot are configured only as uplink symbols 1220 according to a slot format. As another example, in a downlink/uplink mixed slot 1210, some symbols within the slot may be configured as downlink symbols 1225, and some symbols within the slot may be configured as uplink symbols 1235 according to a slot format. In this case, specific symbols of the mixed slot 1210 including both the uplink and downlink symbols may be configured or indicated as a guard period 1230 for downlink-uplink switching, and the terminal may not perform transmission/reception during the guard period 1230.

In the 5G NR communication system, the base station may configure a ‘slot format’ over one or more slots for each serving cell to the terminal through a higher layer parameter tdd-UL-DL-ConfigurationCommon. In this case, the higher layer parameter tdd-UL-DL-ConfigurationCommon may include or refer to at least one of the following information.
Reference subcarrier spacing: reference numerology μ_{ref}
Pattern 1: A first pattern.
Pattern 2: A second pattern.

Here, the pattern 1 or pattern 2 may include at least one of the following configurations.
Slot configuration periodicity (i.e. dl-UL-TransmissionPeriodicity): Slot configuration periodicity P expressed in units of msec
Number of downlink dedicated slots (i.e. nrofDownlinkSlots): The number dₛₗₒₜₛ of slots composed only of downlink symbols
Number of downlink symbols (i.e. nrofDownlinkSymbols): The number d_{sym} of downlink symbols
Number of uplink dedicated slots (i.e. nrofUplinkSlots): The number uₛₗₒₜₛ of slots composed only of uplink symbols
Number of uplink symbols (i.e. nrofUplinkSymbols): The number u_{sym} of uplink symbols

The slot configuration periodicity P msec of the first pattern may include S=P·2^{μ}^{_{ref}} slots, and in this case, the numerology may follow μ_{ref}. In addition, among the S slots, the first dₛₗₒₜₛ slots may include only downlink symbols, and the last uₛₗₒₜₛ slots may include only uplink symbols. In this case, d_{sym} symbols after first dₛₗₒₜₛ slots may be downlink symbols. In addition, u_{sym} symbols before last uₛₗₒₜₛ slots may be uplink symbols. The remaining symbols (i.e. (S−dₛₗₒₜₛ−uₛₗₒₜₛ)·N_{symb}^{slot}−d_{sym}−u_{sym} symbols) that are not designated as downlink symbols or uplink symbols in the pattern may be flexible symbols.

If the second pattern is configured and the slot configuration periodicity of the second pattern is P₂, a slot configuration periodicity P+P₂ msec configured with a combination of the first pattern and the second pattern may include first S=P·2^{μ}^{_{ref}} slots and second S₂=P₂·2^{μ}^{_{ref}} slots. In this case, the positions and numbers of downlink symbols, uplink symbols, and flexible symbols in the second pattern may be configured with reference to the description of the first pattern based on configuration information of the second pattern. In addition, when the second pattern is configured, the terminal may assume that P+P₂ is a divisor of 20 msec.

The base station may override direction(s) of ‘flexible symbol(s)’ among symbols configured through the higher layer parameter tdd-UL-DL-ConfigurationCommon by using the higher layer parameter tdd-UL-DL-ConfigurationDedicated) based on the following information.
Slot configuration set (i.e. slotSpecificConfigurationsToAddModList): A set of slot configurations
Slot index (i.e. slotIndex): An index of a slot included in the set of slot configurations
Symbol directions (i.e. symbols): The directions of the symbols indicated by the slot index (i.e. slotindex). If all symbol directions are downlink (symbols=allDownlink), all symbols within the corresponding slot are downlink symbols. If all symbol directions are uplink (symbols=allUplink), all symbols within the corresponding slot are uplink symbols. If the symbol directions are explicit (symbols=explicit), nrofDownlinkSymbols may indicate the number of downlink symbols located in the first part of the corresponding slot, and nrofUplinkSymbols may indicate the number of uplink symbols located in the last part of the corresponding slot. If nrofDownlinkSymbols or nrofUplinkSymbols is omitted, the corresponding parameter may be regarded as indicating a value of 0. The remaining symbols within the slot become flexible symbols.

In the 5G communication system, the base station may indicate a slot format to the terminal based on L1 signaling. For example, when the terminal receives a higher layer parameter SlotFormatIndicator from the base station, the terminal may obtain configuration information a slot format indication-RNTI (i.e. SFI-RNTI). Meanwhile, when the terminal receives a higher layer parameter dci-PayloadSize from the base station, the terminal may obtain configuration information of a payload size of the DCI format 2_0. In addition, the terminal may additionally receive, from the base station, information on PDCCH candidate(s), CCE aggregation level, and search space set(s) of a CORESET for monitoring the DCI format 2_0. Each slot format indication (SFI) index field in the DCI format 2_0 may indicate a slot format to be applied to each slot in a slot set of a DL BWP and a UL BWP from a slot in which the terminal has detected the corresponding DCI format 2_0. In this case, the size of the slot set may be equal to or greater than a PDCCH monitoring periodicity of the DCI format 2_0. For example, when the slot set is composed of N slots, the DCI format 2_0 may include N SFI index fields, and each SFI index field may indicate a format value of Tables 18 to 20 below. In Tables 18 to 20, ‘D’ may mean a downlink symbol, ‘U’ may mean an uplink symbol, and ‘F’ may mean a flexible symbol.

TABLE 18

| Slot | Symbol number within a slot | | | | | | | | | | | | | |
|---|---|---|---|---|---|---|---|---|---|---|---|---|---|---|
| format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |

TABLE 19

| Slot | Symbol number within a slot | | | | | | | | | | | | | |
|---|---|---|---|---|---|---|---|---|---|---|---|---|---|---|
| format | 0 | 1 | 2 | 3 | 4 | 5 | 6 | 7 | 8 | 9 | 10 | 11 | 12 | 13 |
| 20 | D | D | F | F | F | F | F | F | F | F | F | F | F | U |
| 21 | D | D | D | F | F | F | F | F | F | F | F | F | F | U |
| 22 | D | F | F | F | F | F | F | F | F | F | F | F | U | U |
| 23 | D | D | F | F | F | F | F | F | F | F | F | F | U | U |
| 24 | D | D | D | F | F | F | F | F | F | F | F | F | U | U |
| 25 | D | F | F | F | F | F | F | F | F | F | F | U | U | U |
| 26 | D | D | F | F | F | F | F | F | F | F | F | U | U | U |
| 27 | D | D | D | F | F | F | F | F | F | F | F | U | U | U |
| 28 | D | D | D | D | D | D | D | D | D | D | D | D | F | U |
| 29 | D | D | D | D | D | D | D | D | D | D | D | F | F | U |
| 30 | D | D | D | D | D | D | D | D | D | D | F | F | F | U |
| 31 | D | D | D | D | D | D | D | D | D | D | D | F | U | U |
| 32 | D | D | D | D | D | D | D | D | D | D | F | F | U | U |
| 33 | D | D | D | D | D | D | D | D | D | F | F | F | U | U |
| 34 | D | F | U | U | U | U | U | U | U | U | U | U | U | U |
| 35 | D | D | F | U | U | U | U | U | U | U | U | U | U | U |
| 36 | D | D | D | F | U | U | U | U | U | U | U | U | U | U |
| 37 | D | F | F | U | U | U | U | U | U | U | U | U | U | U |
| 38 | D | D | F | F | U | U | U | U | U | U | U | U | U | U |
| 39 | D | D | D | F | F | U | U | U | U | U | U | U | U | U |

TABLE 20

| Slot | Symbol number within a slot | | | | | | | | | | | | | |
|---|---|---|---|---|---|---|---|---|---|---|---|---|---|---|
| format | 0 | 1 | 2 | 3 | 4 | 5 | 6 | 7 | 8 | 9 | 10 | 11 | 12 | 13 |
| 40 | D | F | F | F | U | U | U | U | U | U | U | U | U | U |
| 41 | D | D | F | F | F | U | U | U | U | U | U | U | U | U |
| 42 | D | D | D | F | F | F | U | U | U | U | U | U | U | U |
| 43 | D | D | D | D | D | D | D | D | D | F | F | F | F | U |
| 44 | D | D | D | D | D | D | F | F | F | F | F | F | U | U |
| 45 | D | D | D | D | D | D | F | F | U | U | U | U | U | U |
| 46 | D | D | D | D | D | F | U | D | D | D | D | D | F | U |
| 47 | D | D | F | U | U | U | U | D | D | F | U | U | U | U |
| 48 | D | F | U | U | U | U | U | D | F | U | U | U | U | U |
| 49 | D | D | D | D | F | F | U | D | D | D | D | F | F | U |
| 50 | D | D | F | F | U | U | U | D | D | F | F | U | U | U |
| 51 | D | F | IF | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |

| | |
|---|---|
| 56-254 | Reserved |
| 255 | UE determines a slot format of a slot based on a higher layer parameter tdd- |
| | UL-DL-ConfigurationCommon or a higher layer parameter tdd-UL-DL- |
| | ConfigurationDedicated, and a detected DCI format (when exists). |

In the 5G NR communication system, through an integrated access and backhaul (IAB) feature, it may be possible to support flexible and dense wireless backhaul links for respective cells without wired network support.

In general, it may be impossible to force all terminals to implement the same features. A UE capability report may allow a high-cost terminal to implement a large amount of features with high performance, and may allow a low-cost terminal to implement a small amount of features with low performance. The UE capability report may secure implementation flexibility of a terminal for such various situations, and may also allow a terminal to report capability information to a network so that a base station can configure respective features within limits supported by each terminal. Certain features may be agreed to be mandatorily implemented by all terminals, and in this case, a UE capability report for the corresponding features may be omitted.

A terminal may perform UE capability reporting with different values for one feature according to frequency bands or according to duplex schemes. For example, a terminal may report to a base station that the terminal supports a specific feature for frequency range 1 (FR1) meaning a band below 6 GHZ, but does not support the corresponding feature for frequency range 2 (FR2) meaning a band above 6 GHz. As another example, a terminal may report to a base station that the terminal supports a specific feature in TDD but does not support the corresponding feature in FDD.

When a terminal performs UE capability reporting, a base station needs to perform configuration, indication, or scheduling for the terminal while respecting (not violating) the UE capability report. This means that, when the base station indicates, to the terminal, configuration, indication, or scheduling that contradicts the UE capability report, the terminal may ignore the configuration, indication, or scheduling.

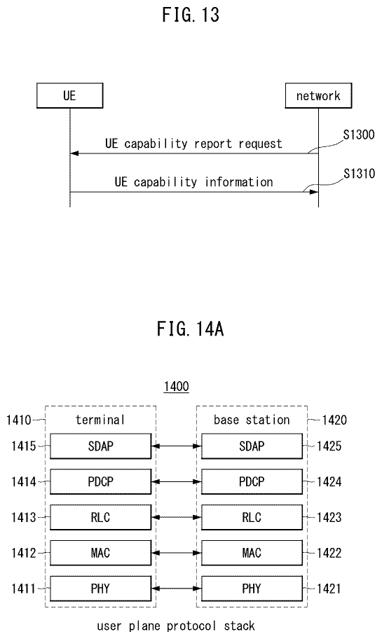

FIG. 13 is a sequence chart illustrating an exemplary embodiment of a UE capability reporting procedure in a communication system.

Referring to FIG. 13, in the UE capability reporting procedure, the base station may transmit a UE capability report request signal to the terminal through a higher layer parameter UECapabilityEnquiry when the terminal is in RRC connected mode (i.e. RRC_CONNECTED state) (S1300). In this case, the network may refer to only the UE capability report after access stratum (AS) security activation, and may not retransmit or report the UE capability report before the AS security activation to the core network (CN). Upon receiving the UE capability report request signal, the terminal may compile UE capability information according to a specific procedure, and report it to the base station through a UE capability information signal (e.g. UECapabilityInformmation) (S1310).

The specific procedure for compiling the UE capability information signal may include a procedure of generating at least one of a list (i.e. supportedBandCombinationList) of band(s) or band combination(s) (BC(s)) supported by the terminal, feature set (FS) information related to feature sets supported by the terminal, or feature set combination (FSC) information related to feature set combinations supported by the terminal. For example, when the base station requests a UE capability report from the terminal in order to obtain information on band(s) or band combination(s) supported by the terminal, the terminal may report which band(s) it supports for each radio access technology (RAT). To this end, the base station may set a RAT-type in a UE RAT capability report request signal (e.g. UE-CapabilityRAT-Request), which is included in a UE RAT capability report request list signal (e.g. ue-CapabilityRAT-RequestList) that is a higher layer message, to one of ‘nr’, ‘eutra-nr’, ‘eutra’, and ‘eutra-fdd’.

This may mean that the base station may request a UE capability report for one or more RATs or RAT combinations from the terminal, and in this case, the terminal may respond to each request for a list of support bands for a plurality of RATs or RAT combinations. For example, if the RAT-type is set to ‘nr’, the terminal may include a list of bands or band combinations to which NR-DC can be applied in the UE capability report. As another example, if the RAT-type is set to ‘eutra-nr’, the terminal may include a list of bands or band combinations applicable to multi-RAT DC (MR-DC) such as EN-DC, NGEN-DC, NE-DC, or the like in the UE capability report. In addition, when the base station requests a UE capability report, the base station may provide, to the terminal, a list of bands for which the terminal determines whether support is provided, through a higher layer parameter frequencyBandListFilter. For the bands included in the higher layer parameter frequencyBandListFilter, the terminal may determine a candidate band combination by considering ‘predetermined RAT types supported for each band’, ‘information on RAT-types requested by the base station’, etc., and may include the candidate band combination in the UE capability report.

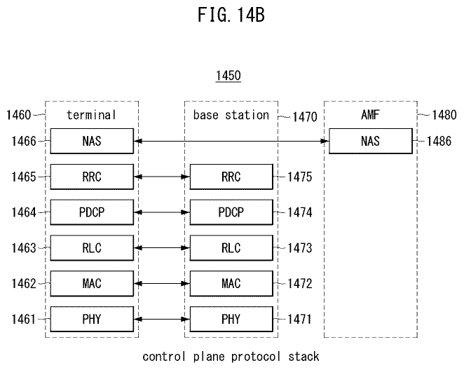

FIGS. 14A and 14B are conceptual diagrams for describing a first exemplary embodiment of a user plane protocol stack structure and a control plane protocol stack structure in a communication system.

Referring to FIGS. 14A and 14B, a radio interface protocol stack or radio interface protocol stack structures 1400 and 1450 may be defined in a radio connection section between communication nodes. For example, the radio interface protocol stack may be divided into a physical layer, a data link layer, a network layer, and the like, which are vertically configured.

The radio interface protocol stack may be divided into the user plane protocol stack 1400 and the control plane protocol stack 1450. Here, the control plane may be a plane for transmitting a control signal. The control signal may be referred to as a signaling signal. The user plane may be a plane for transmitting user data.

Referring to FIG. 14A, the communication system may include a terminal 1410 and a base station 1420. The terminal 1410 may be referred to as a user equipment (UE). The base station 1420 may correspond to an eNB, a gNB, or the like. The terminal 1410 and the base station 1420 may perform mutual data signal transmission/reception based on the user plane protocol stack structure 1400 shown in FIG. 14A.

In the user plane air interface protocol stack structure 1400 of the communication system, the terminal 1410 and the base station 1420 may include PHY layers 1411 and 1421 included in L1, MAC layers 1412 and 1422, RLC layers 1413 and 1423, and packet data convergence protocol (PDCP) layers 1414 and 1424 included in L2, service data adaptation protocol (SDAP) layers 1415 and 1425 included in L3, and the like.

Referring to FIG. 14B, the communication system may include a terminal 1460 and a base station 1470. The terminal 1460 and the base station 1470 may perform mutual control signal transmission/reception based on the control plane protocol stack structure 1450 shown in FIG. 14B.

In the control plane protocol stack structure 1450 of the communication system, the terminal 1460 and the base station 1470 may include PHY layers 1461 and 1471 included in

L1, MAC layers 1462 and 1472, RLC layers 1463 and 1473, and PDCP layers 1464 and 1474 included in L2, and RRC layers 1465 and 1475 included in L3, and the like.

The communication system may further include an Access and Management Mobility Function (AMF) 1480. In the control plane protocol stack structure 1450, the terminal 1460 and the AMF 1480 may include non-access stratum (NAS) layers 1466 and 1486. The base station 1470 may not include a NAS layer. In other words, in the control plane protocol stack structure 1450, the NAS layer of the base station 1470 may be transparent.

The main features of the respective layers of FIGS. 14A and 14B will be described.

In the SDAP layers 1415 and 1425, a single SDAP entity may be configured for each protocol data unit (PDU) session, and in case of dual connectivity (DC), two entities may be configured. In addition, the SDAPlayers 1415 and 1425 may provide Quality of Service (QOS) flows to the 5G core network (5GC) through the following elements:
Improves a QoS flow of a data radio bearer.
DL activates a QoS flow identifier (QFI) for UL implementation.

The PDCP layers 1414 and 1424 for the user plane may provide radio bearers to the SDAP layers 1415 and 1425 through the elements described below.
Sequence numbering
Header compression and decompression
Transfer of user data
Reordering and duplicate detection
PDCP PDU routing
Retransmission of PDCP SDUs
Ciphering and Deciphering
PDCP SDU discard
PDCP re-establishment and data recovery for RLC AM
Duplication of PDCP PDUs

The PDCP layers 1464 and 1474 for the control plane may provide radio bearers to the RRC layers through the elements described below.
Sequence Numbering
Ciphering, deciphering and integrity protection
Transfer of control plane data
Duplicate detection
Duplication of PDCP PDUs

The RRC layers 1765 and 1775 may perform the following operations.
Broadcast of System Information related to AS and NAS
Paging initiated by 5GC or NG-RAN
Establishment, maintenance, and release of RRC connections between a user equipment (UR) and a next generation radio access network (NG-RAN), including addition, modification, and release of carrier aggregation (CA) between NR(s) or E-UTRA(s), and addition, modification, and release of dual connectivity (DC) between NR(s) or E-UTRA(s).
Security functions including key management
Establishment, configuration, maintenance, and release of signaling radio bearers (SRBs) and data radio bearers (DRBs)
Mobility functions including handover and context transfer; UE cell selection and reselection and control of cell selection and reselection; inter-RAT mobility
QoS management functions
UE measurement reporting and control of the reporting
Detection of and recovery from radio link failure
NAS message transfer to/from NAS from/to UE

The MAC layers 1412, 1422, 1462, and 1472 may provide logical channels to the RLC layers through the following elements.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through HARQ
Priority handling between UEs by means of dynamic scheduling
Priority handling between logical channels of one UE by means of logical channel prioritization
Padding

The PHY layers 1411, 1421, 4161, and 1471 may provide transports channel to the MAC layers 1412, 1422, 1462, and 1472, and detailed methods for this are replaced by the overall description of the physical layers in the present disclosure.

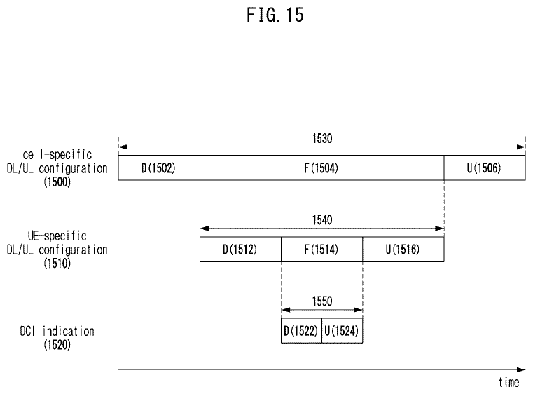

FIG. 15 is a conceptual diagram for describing slot formats within a given time duration in a 5G NR system.

Referring to FIG. 15, within a given time duration, slot formats may be composed of cell-specific downlink (D) 1502, cell-specific flexible (F) 1504, and cell-specific uplink (U) 1506, which are configured by a cell-specific configuration 1500 (e.g. configured by a higher-layer parameter tdd-UL-DL-ConfigurationCommon). The cell-specific flexible 1504 according to the cell-specific configuration 1500 may be further determined in more detail as dedicated downlink (D) 1512, dedicated flexible (F) 1514, and dedicated uplink (U) 1516, which are configured by a terminal-specific configuration 1510 (e.g. configured by a higher-layer parameter tdd-UL-DL-ConfigurationDedicated). In this case, for a region 1550 that is configured as flexible by both the cell-specific F 1504 and the dedicated F 1514, it may be possible to indicate the region as dynamic downlink (D) 1522 or dynamic uplink (U) 1524 by DCI 1520 (e.g. an SFI indicated by DCI format 2_0). The order of downlink and uplink resources illustrated in FIG. 15 is merely an example, and in actual application, the order may be appropriately changed according to a channel environment or an operator preference.

Meanwhile, the 5G communication system may provide technologies for improving wireless coverage and/or technologies for reducing network deployment costs. For example, the 5G communication system may provide an integrated access and backhaul (IAB) technology that provides a wireless backhaul or fronthaul capable of coexisting with a radio access network, and a repeater technology that covers shadow areas at low cost.

An IAB node may be classified as a type of regenerative relay having a structure in which a received signal is fully decoded and then re-encoded and then amplified and transmitted. The IAB node may support a control plane (CP) and a user plane (UP) from an upper node (e.g. a donor IAB node or a parent IAB node) to a terminal (e.g. user equipment (UE)) with a structure including a layer 1 (L1) and a layer 2 (L2) in a protocol stack (in some cases including a layer 3 (L3) or higher). The IAB node having such a structure has an advantage of enabling various operations including conventional base station and terminal operations, but at the same time may cause various problems such as increasing implementation complexity and cost of the IAB node and causing delay required for retransmission.

An RF repeater (or RF relay), in contrast to IAB, is a type of non-regenerative relay that simply amplifies and forwards all received signals.

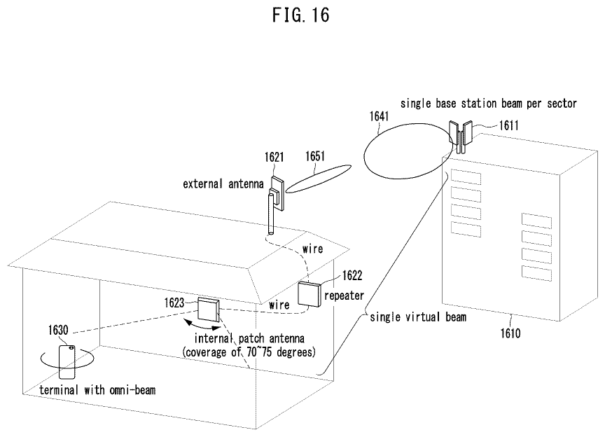

FIG. 16 is a conceptual diagram illustrating deployment of a commercial RF repeater.

Referring to FIG. 16, deployment of a base station 1610 and a commercial RF repeater for receiving wireless signals from the base station 1610 is illustrated. The base station 1610 is exemplified as a base station capable of forming a single beam 1641 for each sector through an antenna 1611. In this case, the base station 1610 may be a base station such as eNB and/or gNB.

In general, the main purpose of commercial RF repeaters is to cover indoor shaded areas. Therefore, the commercial RF repeater may receive signals from the base station 1610 through an outdoor external antenna 1621. The external antenna 1621 may be a directional antenna capable of forming a reception beam 1651 in a specific direction. In addition, the commercial RF repeater may be composed of a repeater unit 1622 that amplifies and retransmits the signals received from the base station, and an indoor patch antenna 1623 that transmits the amplified signals indoors. The external antenna 1621, repeater unit 1622, and internal patch antenna 1623 may be connected through wires as illustrated in FIG. 16. Although FIG. 16 illustrates the case where the external antenna 1621, repeater unit 1622, and internal patch antenna 1623 are connected by wires, they may also be connected wirelessly. Therefore, the internal patch antenna 1623 may perform wireless communication with a terminal 1630. In this case, the terminal 1630 may be a terminal with an omni-beam, as illustrated in FIG. 16, or may be a terminal with a directional beam.

The commercial RF repeater may generally operate in an FR1 band, and in the corresponding frequency band, the base stations 1610 (e.g. eNB, which is an LTE base station, and gNB, which is an NR base station) may operate with one beam per cell or sector. In case of downlink (a link in which signals are transmitted from the base station to the terminal), the external antenna 1621 may be a receiving antenna for receiving signals from the base station, and the internal patch antenna 1623 may be a transmitting antenna for transmitting signals to the terminal 1630. On the other hand, in case of uplink (a link in which signals are transmitted from the terminal to the base station), the external antenna 1621 may be a transmitting antenna, and the internal patch antenna 1623 may be a receiving antenna.

The above-described external antenna 1621, which is generally configured as a directional log-periodic dipole array, may be manually installed to face the direction of the base station. The internal patch antenna 1623, which transmits the amplified/retransmitted signals, may be configured as a patch antenna with an effective coverage of about 70 to 75 degrees, and through this, it may support the terminal 1620 operating with an omni-beam (non-directional beam) indoors.

In the situation as illustrated in FIG. 16, the base station 1610 may recognize ‘base station beam’, ‘beam for the external antenna of the repeater’, and ‘beam for the internal patch antenna of the repeater’ as one transmission beam (i.e. single virtual Tx beam). Similarly, the base station 1610 may recognize ‘beam for the external antenna 1621 of the repeater’, ‘beam for the internal patch antenna 1623 of the repeater’, and ‘terminal beam’ as one reception beam (i.e. single virtual Rx beam).

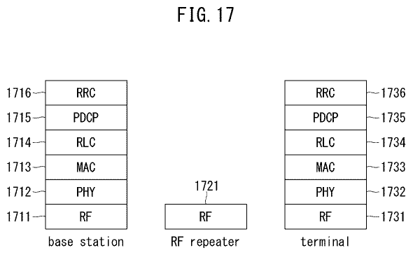

FIG. 17 is a conceptual diagram illustrating a protocol stack for a control plane and a user plane of a wireless communication system including an RF repeater.

A protocol stack of the RF repeater may have the same structure for both a control plane and a user plane. Therefore, the control plane and user plane of the RF repeater may have structures illustrated in FIG. 17.

Referring to FIG. 17, in each of the control plane and user plane for the RF repeater, the base station may include an RF layer 1711, PHY layer 1712, MAC layer 1713, RLC layer 1714, PDCP layer 1715, and RRC layer 1716, and the terminal may also include an RF layer 1731, PHY layer 1732, MAC layer 1733, RLC layer 1734, PDCP layer 1735, and RRC layer 1736. The protocol stacks illustrated in FIG. 17 are the same as the protocol stacks previously described in FIGS. 14A and 14B. Therefore, redundant description will be omitted. However, FIG. 17 is different from FIGS. 14A and 14B in that both the base station and the terminal further includes the RF layers 1711 and 1731. The RF layers 1711 and 1731 may be a general configuration for transmission and reception of RF signals in the wireless communication system such as 3GPP system.

Meanwhile, in FIG. 17, a protocol stack of the repeater, which includes from a PHY layer to an RRC layer, is transparent, and a wireless signal receive by the repeater may be amplified and forwarded from the perspective of an RF 1721 layer.

In the environment illustrated in FIGS. 16 and 17 above, the repeater performs only the simple RF amplification and forwarding function repeatedly, thereby reducing the implementation complexity and cost of the repeater. However, in this situation, since the base station and network cannot explicitly or implicitly manage the repeater, there may be a disadvantage in not being able to explicitly manage the repeater's beams, enhance signal quality, or adjust interference.

The performance of the RF repeater as in FIGS. 16 and 17 may be limited in a time division duplexing (TDD) band (generally, 3.5 GHz band or FR2 band) requiring sophisticated DL/UL switching or in an FR2 band requiring multi-beam operations.

In the 5G NR system, the base station can dynamically indicate a DL/UL direction for each slot and/or symbol to the terminal or IAB node through L1 signaling according to slot format configuration and/or indication. In addition, the base station can dynamically transmit beam/TCI/QCL indication for each channel to the terminal or IAB node. On the other hand, the base station cannot transmit such indication to the RF repeater. Since the RF repeater does not decode a signal transmitted from the base station, even if the base station transmits such indication, the RF repeater is not able to recognize the indication.

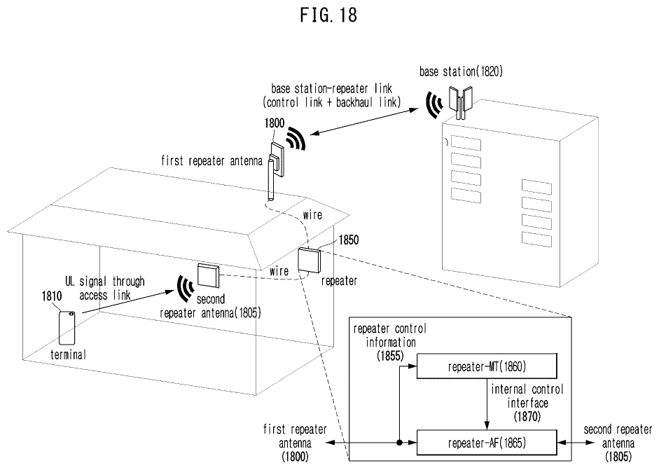

To solve the above-described problem, an advanced repeater (or, smart relay, advanced relay, enhanced relay, low-cost IAB node, network-controlled repeater, NWC repeater, NCR) capable of decoding a part or all of signals transmitted from the base station may be considered. FIG. 18 is a conceptual diagram for describing deployment of a network control repeater.

Referring to FIG. 18, a base station 1820 may transmit and receive RF signals to and from a network-controlled repeater (NCR) through base station antenna(s). In addition, the base station 1820 may transmit and receive RF signals to and from a terminal through the base station antenna(s). The antenna(s) of the base station 1820 may include one or more antennas, and the network-controlled repeater may include antenna groups 1800 and 1805.

A first antenna or antenna group 1800 connected to a repeater signal processing unit may establish a wireless connection with the base station 1820 in an outdoor environment, and a second antenna or antenna group 1805 connected to the repeater signal processing unit may establish a wireless connection with a terminal 1810 in an indoor environment. Accordingly, a network-controlled repeater 1850 may perform a wireless connection between the base station 1820 and the network-controlled repeater through the repeater first antenna 1800. Here, the wireless connection may include a control link and/or a backhaul link through RF signals. In addition, the network-controlled repeater may perform a wireless connection with the terminal 1810 through the repeater second antenna 1805.

A base station-repeater link may be composed of a control link through which a signal for the base station 1820 to control the repeater 1850 is transmitted and a backhaul link through which a signal for the base station 1820 to serve the terminal 1810 is transmitted, and the wireless link between the repeater 1850 and the terminal 1810 may be collectively referred to as an access link.

The repeater 1850 may be composed of a repeater-mobile terminal (MT) 1860 for signal processing and a repeater-amplify and forward (AF) 1865. The repeater-MT 1860 may receive and process a control signal of the base station, and the repeater-AF 1865 may amplify and retransmit a signal of the base station. The repeater 1850 may have additional components in addition to the repeater-MT 1860 and the repeater-AF 1865, but the present disclosure does not describe all such configurations. The repeater-MT 1860 and the repeater-AF 1865 may be connected through an internal control interface 1870.

The repeater-MT 1860 and the repeater-AF 1865 may be connected with the base station 1820 through a wireless link via the first antenna group 1800 of the repeater. In this case, the repeater-MT 1860 may receive repeater control information 2040 via the repeater first antenna 1800, and may indicate corresponding repeater control or operation procedures to the repeater-AF 1865 through the internal control interface 1870. The repeater-AF 1865 may, according to the indicated repeater control or operation procedures, amplify a signal of the base station 1820 received via the repeater first antenna 1800 and retransmit the amplified signal to the terminal 1810 via the repeater second antenna 1805 for downlink relaying, or may amplify a signal of the terminal 1810 received via the repeater second antenna 1805 and retransmit the amplified signal to the base station 1820 via the repeater first antenna 1800 for uplink relaying.

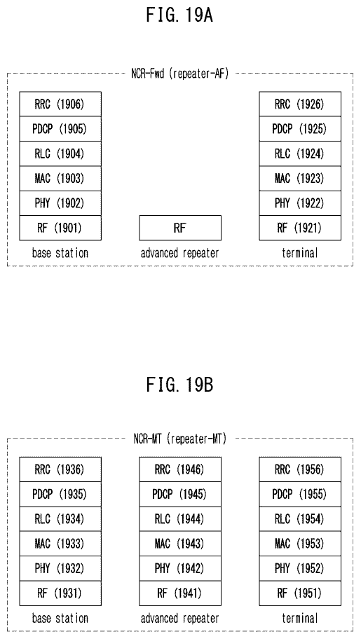

FIG. 19A is a conceptual diagram illustrating an example of a control plane protocol stack of an advanced repeater according to an exemplary embodiment of the present disclosure, and FIG. 19B is a conceptual diagram illustrating an example of a user plane protocol stack of an advanced repeater according to an exemplary embodiment of the present disclosure.

In FIG. 19A, a protocol stack for the repeater AF 1865 of the advanced repeater, as described with reference to FIG. 18, is illustrated, and a protocol stack for the repeater MT 1860 of the advanced repeater, as described with reference to FIG. 18, is also illustrated. Referring to FIG. 19A and FIG. 19B, in a user plane of a wireless communication system including the advanced repeater, a base station and a terminal may include all of a general protocol stack structure including physical (PHY) layers 1902, 1922, 1932, and 1952 referred to as a first layer (L1), MAC layers 1903, 1923, 1933, and 1953 referred to as a second layer (L2), RLC layers 1904, 1924, 1934, and 1954, PDCP layers 1905, 1925, 1935, and 1955, and RRC layers 1906, 1926, 1936, and 1956 referred to as a third layer (L3). The base station and the terminal may transmit and receive signals based on the structure described above through RF functions 1901, 1921, 1931, and 1951.

Meanwhile, in FIG. 19A, from the user plane perspective of the repeater, a protocol stack from the PHY to RRC layers is transparent, and a received wireless signal may be amplified and retransmitted from the perspective of an RF function 1911.

In contrast, when a control plane of a repeater system is considered, in addition to an RF function 1941 of the repeater, a PHY layer 1942, a MAC layer 1943, an RLC layer 1944, a PDCP layer 1945, and an RRC layer 1946 (or a subset of these layers) for management of the repeater by the base station may be added. Such management may include beam configuration, downlink and uplink configuration, slot format configuration, repeater ON-OFF control, and repeater power control. The PHY layer 1942, the MAC layer 1943, the RLC layer 1944, the PDCP layer 1945, and the RRC layer 1946 (or a subset of these layers) may support signaling for beam or slot format management or indication to solve the problems described above, may support signaling of a repeater ON-OFF indicator indicating whether the repeater performs a retransmission operation, may support signaling of a repeater power control indicator for controlling a power of the repeater, or may support signaling of a repeater capability report (or a terminal capability report as a repeater), such that the base station can control various beams, beam combinations, or slot formats within a base station-repeater link and a repeater-terminal link.

The control plane and user plane protocol stacks of the advanced repeater presented in

FIG. 19A and FIG. 19B illustrate some of various repeater implementation methods and are not limited thereto. In other words, depending on a repeater implementation, expansion or omission of protocol layers may be performed as necessary. For example, when a certain repeater implementation or an operation of a certain repeater does not rely on higher-layer signaling, some layers of FIG. 19A or FIG. 19B (e.g. the RRC layer 1946, the PDCP layer 1945, or the RLC layer 1944) may not be included in the repeater. In the present disclosure, not all possible implementation methods are listed in order not to obscure the gist of the description.

A network-controlled repeater may need to transmit two different uplink signals. Examples of the two different uplink signals may be as follows.
1) An uplink signal of a repeater-MT,
2) A signal obtained by amplifying an uplink signal of a terminal, which is received at antenna group #2.

Transmission powers of the different uplink signals described above may be determined based on 5G NR, as shown in Equation 5 below.

$$P ( i , l ) = min \{ \begin{matrix}{P}_{CMAX} ( i ) \\ {P}_{0} ( i ) + 10 log ( {2}^{μ} \times {M}_{RB} ) + α ( i ) \times PL + Δ ( i ) + f ( i , l )\end{matrix} \qquad [ Equation 5 ]$$

In Equation 5, i indicates a transmission occasion, l denotes a closed loop power control adjustment state, P_{CMAX}(i) denotes a maximum transmission power of a terminal, P₀(i) denotes a nominal UE transmission power, 2^{μ} denotes a subcarrier spacing, M_{RB} denotes the number of RBs allocated to uplink transmission, α(i) denotes a fractional power control coefficient, PL denotes a measured pathloss, Δ(i) denotes an offset according to a modulation and coding scheme, and f(i, l) denotes a closed loop power control value.

In Equation 5, although types and definitions of parameters may be partially changed according to a type of a channel or signal (e.g. PUSCH, PUCCH, SRS, or PRACH) transmitted at a transmission occasion, detailed descriptions are omitted so as not to obscure the gist of the description. For example, P_{CMAX}(i) may be expressed as a maximum power P_{CMAX,f,c} that can be used on a carrier f of a serving cell c.

Equation 5 may imply that, when a value of instantaneous transmission power determined at a given transmission time is higher than a value of maximum transmission power determined according to a terminal implementation or a separate base station configuration, a transmission power at the transmission time becomes the maximum transmission power value.

Different uplink signals transmitted by the repeater (i.e. signal #1 (an uplink signal of the repeater-MT transmitted through a control link) and signal #2 (a signal obtained by amplifying an uplink signal of a terminal received at antenna group #2 and transmitted through a backhaul link)) may be classified as follows according to multiplexing modes.
A time division multiplexing (TDM) mode: a case in which signal #1 and signal #2 are transmitted using different time resources
A frequency division multiplexing (FDM) mode: a case in which signal #1 and signal #2 are transmitted using the same time resource (or partially overlapping time resources) but using different frequency resources.
A spatial division multiplexing (SDM) mode: a case in which signal #1 and signal #2 are transmitted using the same time and frequency resource (or partially overlapping time and frequency resources) but using different spatial resources such as beams or antenna domains.

Meanwhile, considering that the maximum value P_{CMAX}(i) of uplink transmission power in Equation 5 may be determined for each uplink cell, it can be inferred that a value of P_{CMAX}(i) for each uplink cell may be determined differently according to an actual configuration applied to the repeater among various uplink power amplifier configuration combinations described above. In other words, the value of P_{CMAX}(i) may be determined according to the number of power amplifiers allocated to each uplink cell or according to the number of uplink cells that each power amplifier is required to support.

On the other hand, the 3GPP Rel-18 NR technical specifications provide beam indication methods or ON-OFF indication methods for a network-controlled repeater (NCR).

For example, a base station may perform various types of beam indications, such as aperiodic (Ap), semi-persistent (Sp), or periodic (P) beam indication, for an NCR MT, that is, for repeater beam indication for a link between the first repeater antenna 1800 and the terminal 1810. The Ap, Sp, or P beam indications may be configured by a combination of RRC configuration, MAC CE, and DCI for beam indication, and each beam indication may include at least one of the following items (or at least one of indexes corresponding to combinations thereof).
a) Beam index
b) Time resource (e.g. slot or symbol) index
c) Slot (pattern) period
d) Slot offset
e) Symbol (pattern) period
f) Symbol offset

When different types of beam indications overlap and are allocated to a certain time resource, the NCR may apply a priority order of “Ap>Sp>P”. For example, when an Ap beam indication and an Sp beam indication overlap in a certain time resource, the NCR may ignore the Sp beam indication and apply only the Ap beam indication for the time resource. As another example, when an Ap beam indication and a P beam indication overlap in a certain time resource, the NCR may ignore the P beam indication and apply only the Ap beam indication for the time resource. As still another example, when an Sp beam indication and a P beam indication overlap in a certain time resource, the NCR may ignore the P beam indication and apply only the Sp beam indication for the time resource.

When different types of beam indications overlap and are allocated to a certain time resource and an Sp beam indication or a P beam indication is configured with or associated with a priority flag, the NCR may apply a priority order of “Sp with a priority flag>Ap” or “P with a priority flag>Ap”. For example, when an Ap beam indication and an Sp beam indication with a priority flag overlap in a certain time resource, the NCR may ignore the Ap beam indication and apply only the Sp beam indication with the priority flag for the time resource. As another example, when an Ap beam indication and a P beam indication with a priority flag overlap in a certain time resource, the NCR may ignore the Ap beam indication and apply only the P beam indication with the priority flag for the time resource.

The NCR complying with the Rel-18 NR technical specifications may not expect to receive multiple different P beam indications indicating different beams in the same time resource (or at a specific time). This may mean that, in the Rel-18 NR specification, when multiple P beam indications collide with each other, an NCR operation in the corresponding time resource is not defined.

The NCR complying with the Rel-18 NR technical specifications may not expect to receive multiple different Sp beam indications indicating different beams in the same time resource (or at a specific time). This may mean that, in the Rel-18 NR specification, when multiple Sp beam indications collide with each other, an NCR operation in the corresponding time resource is not defined.

The NCR complying with the Rel-18 NR technical specifications, when receiving multiple different Ap beam indications indicating different beams in the same time resource (or at a specific time), may apply only the most recently received Ap beam indication. This may mean that, in the Rel-18 NR specification, when multiple Ap beam indications collide with each other, only one most recent Ap beam indication is valid in the corresponding time resource.

The NCR complying with the Rel-18 NR technical specifications does not perform a retransmission operation in a time resource to which no beam indication is allocated. In other words, in the corresponding time resource, an output of the NCR-Fwd (i.e. the repeater AF) 1865 may be in an OFF state and may need to be maintained at a value smaller than a pre-agreed specific value.

The NCR complying with the Rel-18 NR technical specifications may select at most one beam indication in a certain time resource (or at a specific time) according to the beam priority and beam determination rules described above and may use the selected beam indication for access link transmission and reception. The NCR complying with the Rel-18 NR technical specifications does not serve multiple terminals simultaneously, does not connect to multiple base stations simultaneously, and does not support multi-carrier operations or scenarios such as carrier aggregation (CA) or dual connectivity (DC). Accordingly, all intended scenarios may be supported only with the single-beam operation described above.

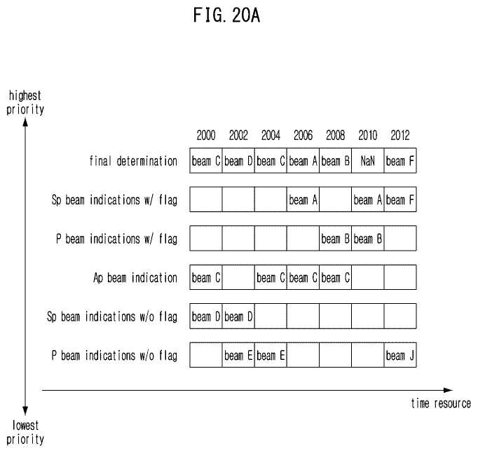

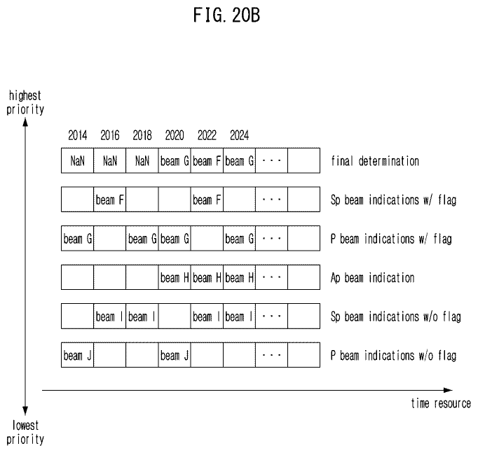

FIG. 20A is a conceptual diagram illustrating examples of a temporal part of a single-beam priority determination method according to an exemplary embodiment of the present disclosure, and FIG. 20B is a conceptual diagram illustrating examples of a remaining part of the single-beam priority determination method according to an exemplary embodiment of the present disclosure.

First, referring to FIG. 20A, when an Sp beam indication or a P beam indication is not associated with a priority flag (or is not configured together with a priority flag) and overlaps with (or is indicated together with) an Ap beam indication indicating a different beam, an NCR may determine a beam according to the Ap beam indication for supporting an access link (2000, 2004).

Referring to FIG. 20A, when an Sp beam indication and a P beam indication indicating different beams are not associated with a priority flag (or are not configured together with a priority flag) and overlap with each other (or are indicated together), the NCR may determine a beam according to the Sp beam indication for supporting an access link 2002. Referring to FIG. 20A, when an Sp beam indication or a P beam indication is associated with a priority flag (or is configured together with a priority flag) and overlaps with an Ap beam indication indicating a different beam, the NCR may determine a beam according to the Sp beam indication or the P beam indication for supporting an access link (2006, 2008).

Considering that a priority of an Sp beam indication is higher than a priority of a P beam indication and that a priority of a beam indication associated with a priority flag is higher than a priority of a beam indication not associated with a priority flag, when an Sp beam indication associated with a priority flag and a P beam indication not associated with a priority flag overlap with each other (or are indicated together), the NCR may determine a beam for supporting an access link according to the Sp beam indication associated with the priority flag (2012).

On the other hand, a beam determination such as in the present example may be difficult to apply to other cases in which a priority by a beam type and a priority by a priority flag do not coincide (2010, 2014, 2016, 2018).

For example, when an Sp beam indication and a P beam indication that are associated with a priority flag (or configured together with a priority flag) and indicate different beams overlap with each other, ambiguity may occur in interpretation of beam indications due to the presence of the priority flags, and the NCR may not be able to determine a beam for supporting an access link 2010. In FIG. 20A, inability of the NCR to determine a beam for supporting an access link is indicated as “NaN”.

As another example, when a P beam indication associated with a priority flag and an Sp beam indication not associated with a priority flag overlap with each other, the NCR may not be able to determine a beam for supporting an access link due to ambiguity in an order of priority application (2018).

As still another example, when a P beam indication associated with a priority flag and a P beam indication not associated with a priority flag overlap with each other, the NCR may not be able to determine a beam for supporting an access link based on a specification that beam indications of the same type do not overlap (2014).

As yet another example, when an Sp beam indication associated with a priority flag and an Sp beam indication not associated with a priority flag overlap with each other, the NCR may not be able to determine a beam for supporting an access link based on a specification that beam indications of the same type do not overlap (2016).

In order to resolve the ambiguity of the priority application order described above, the base station may cause three or more access link beam indications to collide in a time resource in which beam indications overlap for the NCR(−MT).

For example, the base station may allocate, to the NCR(−MT), a P beam indication associated with a priority flag, an Ap beam indication, and a P beam indication not associated with a priority flag that overlap in a specific time resource. This may be understood as additionally allocating an Ap beam indication in order to resolve the case of 2014 described above. In this case, the NCR may select an Ap beam indication according to “priority 1: Ap beam indication>P beam indication not associated with a priority flag”, and thereafter may select the P beam indication associated with the priority flag according to “priority 2: Ap beam indication<P beam indication associated with a priority flag”, thereby determining a beam for supporting an access link (2020).

As another example, the base station may allocate, to the NCR(−MT), an Sp beam indication associated with a priority flag, an Ap beam indication, and an Sp beam indication not associated with a priority flag that overlap in a specific time resource. This may be understood as additionally allocating an Ap beam indication in order to resolve the case of 2016 described above. In this case, the NCR may select an Ap beam indication according to “priority 1: Ap beam indication>Sp beam indication not associated with a priority flag”, and thereafter may select the Sp beam indication associated with the priority flag according to “priority 2: Ap beam indication<Sp beam indication associated with a priority flag”, thereby determining a beam for supporting an access link (2022).

As still another example, the base station may allocate, to the NCR(−MT), a P beam indication associated with a priority flag, an Ap beam indication, and an Sp beam indication not associated with a priority flag that overlap in a specific time resource. This may be understood as additionally allocating an Ap beam indication in order to resolve the case of 2018 described above. In this case, the NCR may select an Ap beam indication according to “priority 1: Ap beam indication>Sp beam indication not associated with a priority flag”, and thereafter may select the P beam indication associated with the priority flag according to “priority 2: Ap beam indication<P beam indication associated with a priority flag”, thereby determining a beam for supporting an access link (2024).

The base station and the NCR may remove ambiguity in access link beam indications and increase beam indication efficiency by using at least one of the methods described above.

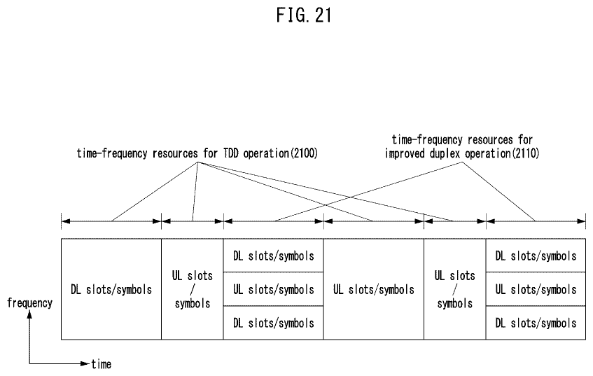

FIG. 21 is a conceptual diagram for describing a method in which a base station allocates time-frequency resources to a terminal according to an operation mode. Referring to FIG. 21, a base station may allocate a first operation mode to a certain time, frequency, space, or code resource. In this case, the first operation mode may be a basic mode that is applied to all available resources without relying on any specific configuration, activation, or indication, may be set, activated, or indicated as a fallback or default mode, or may be configured to have the highest priority. The base station may allocate one or more additional operation modes (e.g. a second operation mode or a third operation mode) to resources that overlap with or do not overlap with resources to which the first operation mode is allocated. In this case, the base station may simultaneously allocate two or more different operation modes to a specific resource. For example, two or more different operation modes may be simultaneously configured by the base station for the same resource, or an operation mode applied to a specific resource may be dynamically changed by a MAC CE or DCI.

The types of operation modes may be classified according to the type of duplex applied to a certain resource. For example, a first operation mode may be one of a TDD mode, an FDD mode, or a limited version thereof (e.g. semi-static TDD excluding dynamic TDD capable of dynamically changing uplink and downlink directions in a specific time resource based on DCI format 2_0) allocated to a certain resource. A second operation mode may be one of improved duplex modes such as dynamic TDD, subband non-overlapping full-duplex (SBFD), or overlapping or inband full duplex (FD) allocated to a certain resource.

The types of operation modes described above may be classified according to a network type applied to or assumed for a certain resource. For example, the first operation mode may indicate a case in which a terrestrial network (TN) is allocated to a certain resource, and the second operation mode may indicate a case in which a non-terrestrial network (NTN) is allocated to a certain resource.

The definitions or classifications of operation modes as described above may be based on various applications (e.g. one operation mode being configured as a combination of various classification conditions), and are not limited to a specific exemplary embodiment.

FIG. 21 illustrates a specific example of a method in which a base station allocates one or more operation modes to a terminal within a certain resource duration. Referring to FIG. 21, a base station may operate in a TDD mode in a certain time duration 2100, and may operate in an improved duplex mode in another time duration 2110. The improved duplex mode may indicate one of flexible duplex modes including SBFD and full-duplex (or in-band full-duplex). However, the present disclosure is not limited to such a specific form.

In the following description, for convenience, the second operation mode 2110 may be collectively referred to as a full-duplex communication mode. In order to support the improved duplex mode, the base station may allocate downlink slots or symbols to a specific terminal (or group) for specific frequency resources (or group), and may allocate uplink slots or symbols to another terminal (or group) for other frequency resources (or groups) within the same time duration. Various operation modes may be assigned semi-statically to respective resources based on higher-layer signaling (e.g. F1AP, SIB, RRC, or MAC CE), or may be assigned dynamically based on L2 or L1 signaling such as MAC CE or DCI.

The second operation mode may be a mode that improves uplink throughput by simultaneously performing transmission and reception by dividing a TDD carrier into subbands within the same slot. Referring to FIG. 21, the terminal may be configured with an SBFD subband configuration for the second operation mode by at least one of a semi-static indication method or a dynamic indication method by the base station.

As a specific example, the terminal may receive frequency indication signaling and time indication signaling specifying time and frequency resources for an uplink subband. The terminal may identify a time duration and frequency resources corresponding to the uplink subband based on the indication information received from the base station, and may perform uplink transmission in the identified duration. Here, the time duration corresponding to the uplink subband may overlap with a time duration of slots or flexible slots in which downlink reception of the first operation mode determined based on a slot format configuration is performed. In other words, based on the slot format configuration, the uplink subband may be configured based on an indication for the SBFD subband configuration in a duration in which downlink reception of the first operation mode is performed. From a network perspective, uplink transmission of the second operation mode and downlink reception of the first operation mode or the second operation mode may be simultaneously performed. As another example, even from the same terminal perspective, uplink transmission of the second operation mode and downlink reception of the first operation mode or the second operation mode may be simultaneously performed.

For example, the terminal may obtain, as an SBFD subband configuration, a configuration for a downlink subband, an uplink subband, or a guard band as a cell-specific configuration. As another example, the terminal may obtain, as an SBFD subband configuration, a configuration for a downlink subband, an uplink subband, or a guard band as a UE-specific or dedicated configuration. As still another example, a downlink subband, an uplink subband, or a guard band may be dynamically indicated through DCI as the SBFD subband configuration.

As still another example, a terminal that supports or is aware of SBFD may receive, based on an existing slot format configuration, a subband configuration different from a slot format indicated for a specific subband of a TDD carrier for a specific time duration, and accordingly may perform either transmission or reception in the specific time duration. As still another example, a terminal that supports or is aware of SBFD and is capable of performing simultaneous uplink and downlink transmission and reception may receive, based on an existing slot format configuration, a subband configuration different from a slot format indicated for a specific subband of a TDD carrier for a specific time duration, and accordingly may simultaneously perform transmission and reception or selectively perform one of transmission and reception in the specific time duration.

Meanwhile, RF repeaters and network-controlled repeaters supported in 5G NR may currently be limited in function to support only a limited form of the first operation mode (FDD or semi-static TDD). Due to such a limitation, usage may be restricted in a network in which operation modes other than the first operation mode (e.g., dynamic TDD, SBFD, and FD) coexist.

In exemplary embodiments described below, methods for controlling a repeater (i.e. NCR) in a network in which various operation modes coexist are provided together with specific examples.

In exemplary embodiments described below, provided methods may be similarly applied even when a transmission power of a repeater is controlled not only by an absolute value of transmission power but also by another method (e.g. a relative value such as repeater gain control for a received signal).

In exemplary embodiments described below, for convenience of description, some NCR-MT operations are described, but such operations may be understood as terminal (UE or UT) operations in actual application.

The methods described based on a repeater (i.e. NCR) in the exemplary embodiments described below may be similarly extended or applied to various types of relays, such as a 6G repeater, a smart repeater, or a reconfigurable intelligent surface (RIS).

### First Exemplary Embodiment: Method for Controlling a Repeater in a Network Using Multiple Operation Modes

According to an exemplary embodiment of the present disclosure, a certain network may be configured with one or more operation modes. For example, all or part of time-frequency resources of a certain cell may be allocated to operate in a first operation mode, such that uplink and downlink directions are determined according to a semi-static TDD DL-UL configuration, and all or part of time-frequency resources of the cell may be allocated to operate in a second operation mode, such that uplink and downlink directions are determined according to a dynamic TDD configuration or indication, or an SBFD configuration. In this case, a coverage area covered by the first operation mode and a coverage area covered by the second operation mode may be different.

For example, the first operation mode may be allocated to cover both an urban area and a suburban area, and the second operation mode may be allocated to cover only the suburban area in which an uplink coverage issue is more pronounced. When a repeater is included in the network, a boundary region of an area covered by a specific operation mode may need to appropriately control interference affecting other operation modes by limiting signal amplification of the repeater.

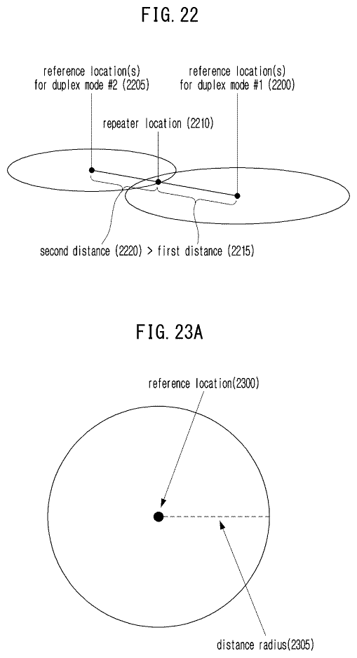

FIG. 22 is a conceptual diagram for describing an example of controlling a repeater in consideration of an operation mode according to an exemplary embodiment of the present disclosure.

Referring to FIG. 22, a certain network may simultaneously operate multiple operation modes, and physical locations in which the respective operation modes are applied may be different from each other (2200, 2205). For example, a first operation mode may be used as semi-static TDD based on a location of a legacy base station 2200, and a second operation mode may be used as dynamic TDD or SBFD based on another location of a new base station supporting dynamic TDD or SBFD 2205. In order to distinguish the first operation mode and the second operation mode, a reference location of an area to which the first operation mode is applied, or a set or list of reference locations, may be defined as absolute geographic information or relative geographic information. The reference location or the set or list of reference locations may be configured for a repeater through higher-layer signaling, may be configured for a terminal, or may be shared between base stations. Similarly, a reference location of an area to which the second operation mode (or one or more additional operation modes other than the first operation mode) is applied, or a set or list of reference locations may be defined as absolute geographic information or relative geographic information, and the reference location or the set or list of reference locations may be configured for a repeater through higher-layer signaling, may be configured for a terminal, or may be shared between the base stations. The reference location of the operation mode or the set or list of reference locations may be configured together with configuration information for the operation mode. Configuration information for the operation mode may include information on a duplex mode and frequency resources, and one or more of time resources, space resources, and code resources to be used in the duplex mode. In addition, information on the first operation mode may be received from the first base station, and information on the second operation mode may be received from the second base station. The first base station and the second base station may refer to base stations having different physical cell identifiers (PCIs). In other words, the first base station and the second base station may refer to different cells.

The repeater (or terminal) may obtain location information of the repeater (or terminal) through external signals such as GNSS signals, internal signals of the system such as positioning reference signal (PRS), or a base station configuration (2210). The repeater (or terminal) may calculate a first distance 2215 between a reference location 2200 of the first operation mode and a location 2210 of the repeater (or terminal) based on the obtained location of the repeater (or terminal). The calculated distance may be a geometric distance. In some exemplary embodiments, the first distance 2215 may have the same meaning as a radio distance in a wireless transmission perspective, such as a degree of signal attenuation, or may have a meaning similar to the radio distance in a wireless transmission perspective.

Similarly, the repeater (or terminal) may calculate a second distance 2220 between a reference location 2205 of the second operation mode and the location 2210 of the repeater (or terminal) based on the obtained location of the repeater (or terminal). The second distance 2220 may also be a geometric distance. In some exemplary embodiments, the second distance 2220 may have the same meaning as a radio distance in a wireless transmission perspective, such as a degree of signal attenuation, or may have a meaning similar to the radio distance in a wireless transmission perspective.

As described above, for the purpose of reducing interference to the first operation mode, when the second distance is longer than the first distance (i.e. when the location of the repeater is closer to an area to which the first operation mode is applied than to an area to which the second operation mode is applied), the repeater (or terminal) may be configured or indicated by a base station, or may be defined by technical specifications, not to perform amplification and retransmission for the second operation mode. Accordingly, NCR-Fwd may be turned OFF in at least one of time resources, frequency resources, space resources, or code resources to which the second operation mode is applied. The operation of amplification and retransmission of a signal may also be referred to as a relay operation. In addition, in the first exemplary embodiment of the present disclosure, interference for a specific mode may indicate interference occurring because at least some resources among resources of the first operation mode and resources of the second operation mode are the same in a situation in which relay operations of the first operation mode and the second operation mode are required. The resources may indicate one or more of time resources, frequency resources, space resources, and code resources.

As another example, for the purpose of reducing interference to the first operation mode, when the second distance is longer than a certain threshold (i.e. when the location of the repeater is separated from the area to which the second operation mode is applied by a certain level or more), the repeater (or terminal) may be configured or indicated by the base station, or may be promised by technical specifications, not to perform amplification and retransmission for the second operation mode, such that NCR-Fwd is turned OFF in at least one of time resources, frequency resources, space resources, and code resources to which the second operation mode is applied.

As still another example, for the purpose of reducing interference to the first operation mode, when the first distance is shorter than a certain threshold (i.e. when the location of the repeater is closer to an area to which the first operation mode is applied by a certain level or more), the repeater (or terminal) may be configured or indicated by the base station, or may be promised by technical specifications, not to perform amplification and retransmission for the second operation mode, such that NCR-Fwd is turned OFF in at least one of time resources, frequency resources, space resources, and code resources to which the second operation mode is applied.

As described above, for the purpose of reducing interference to the first operation mode, when the second distance is shorter than the first distance (i.e. when the location of the repeater is closer to an area to which the second operation mode is applied than to an area to which the first operation mode is applied), the repeater (or terminal) may be configured or indicated by the base station, or may be promised by technical specifications, to perform amplification and retransmission for the second operation mode, such that NCR-Fwd is turned ON in at least one of time resources, frequency resources, space resources, and code resources to which the second operation mode is applied.

As another example, for the purpose of reducing interference to the first operation mode, when the second distance is shorter than a certain threshold (i.e. when the location of the repeater is closer to an area to which the second operation mode is applied by a certain level or more), the repeater (or terminal) may be configured or indicated by the base station, or may be promised by technical specifications, to perform amplification and retransmission for the second operation mode, such that NCR-Fwd is turned ON in at least one of time resources, frequency resources, space resources, and code resources to which the second operation mode is applied.

As still another example, for the purpose of reducing interference to the first operation mode, when the first distance is longer than a certain threshold (i.e. when the location of the repeater is separated from an area to which the first operation mode is applied by a certain level or more), the repeater (or terminal) may be configured or indicated by the base station, or may be promised by technical specifications, to perform amplification and retransmission for the second operation mode, such that NCR-Fwd is turned ON in at least one of time resources, frequency resources, space resources, and code resources to which the second operation mode is applied.

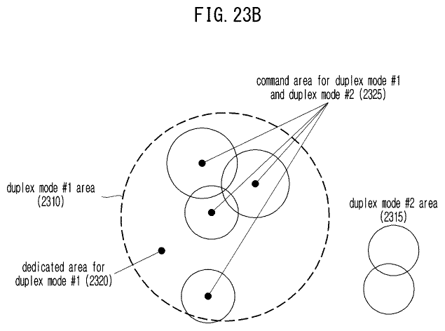

FIG. 23A is a conceptual diagram for describing a method of defining a physical location in which an operation mode is operated according to an exemplary embodiment of the present disclosure.

Referring to FIG. 23A, a certain network may simultaneously operate one or more operation modes. An operation mode operated by the network may have a physical location. The physical location of the operation mode operated by the network may be defined as a reference location 2300 and a distance radius 2305 as illustrated in FIG. 23A. Accordingly, as information for operating the operation mode, the network may allocate the reference location 2300 and the distance radius 2305 to a repeater, or may share the reference location 2300 and the distance radius 2305 between base stations, or may allocate the reference location 2300 and the distance radius 2305 to a terminal. The reference location 2300 and the distance radius 2305 as information for operating the operation mode may be allocated to the repeater, may be shared between base stations, or may be allocated to a terminal through higher-layer signaling or L1 signaling.

FIG. 23B is a conceptual diagram for describing a case of controlling a repeater in consideration of an operation mode according to an exemplary embodiment of the present disclosure.

Referring to FIG. 23B, information on one or more reference locations and radius values 2310, 2315 may be configured for different operation modes. In FIG. 23B, a radius 2310 indicated by a dotted line may correspond to a duplex mode #1, and radii 2315 indicated by solid lines may correspond to a duplex mode #2. The radius information items 2310, 2315 may be allocated to the repeater, may be shared between base stations, or may be allocated to a terminal through higher-layer signaling or L1 signaling, as described in FIG. 23A.

The repeater (or terminal) may distinguish, based on physical locations of the operation modes, an area 2325 to which one or more operation modes are commonly applied and areas 2320 to which only one operation mode is applied.

The repeater may be configured by the base station, or may be defined by technical specifications, to perform one of the following operations within the area 2325 to which one or more operation modes are commonly applied: 1) performing relay only for an operation mode having the highest priority, 2) performing relay for all operation modes, or 3) stopping relay for all operation modes. Through such configuration or technical specifications, interference for different operation modes on a per-area basis may be mitigated.

The repeater may be configured by the base station, or may be defined by technical specifications, to perform one of the following operations within an area 2320 to which one operation mode is applied: 1) performing relay only for the corresponding operation mode, or 2) stopping relay for all operation modes. Through such configuration or technical specifications, interference for different operation modes on a per-area basis can be mitigated. In an exemplary embodiment of the present disclosure, the network may allocate an association between operation mode service areas 2300, 2305 and operation modes to the repeater by various methods. For example, a certain operation mode configuration may be configured (or indicated) through a signaling structure including information on a service area of the corresponding operation mode. As another example, a certain operation mode configuration (or certain service area information) may include an ID for service area information associated with the corresponding operation mode (i.e. an indicator for an operation mode configuration associated with the service area information).

In an exemplary embodiment of the present disclosure, service area information may be defined or configured to include one of a reachable or usable range of uplink signals amplified and retransmitted by the repeater, a reachable or usable range of downlink signals, or a reachable or usable range of both uplink and downlink signals. In this case, the repeater may apply one of the operations described above to an area in which a service area of the repeater overlaps with a service area for the operation mode.

### Second Exemplary Embodiment: Method for Controlling a Repeater in a Network Including Various Types of Terminals

According to an exemplary embodiment of the present disclosure, a certain network may be configured with one or more operation modes. For example, all or part of time-frequency resources of a certain cell may be allocated to operate in a first operation mode, such that uplink and downlink directions are determined according to a semi-static TDD DL-UL configuration, and all or part of time-frequency resources of the cell may be allocated to operate in a second operation mode, such that uplink and downlink directions are determined according to a dynamic TDD configuration or indication, or an SBFD configuration. In this case, terminals existing in the network may have the capability to support the first operation mode and the second operation mode. For example, a certain terminal may support only the first operation mode, another terminal may support only the second operation mode, and still another terminal may support both the first operation mode and the second operation mode.

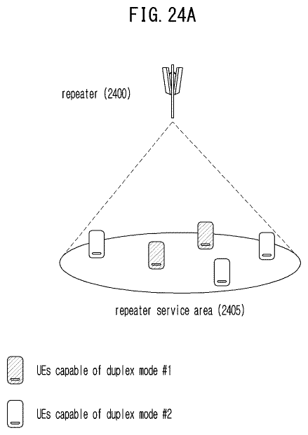

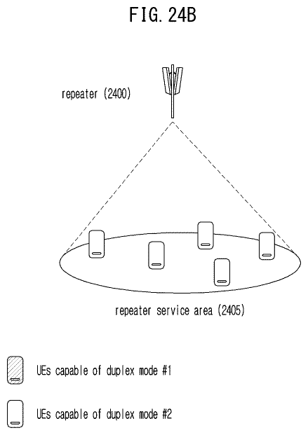

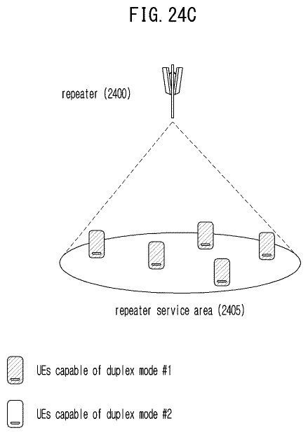

FIG. 24A is a conceptual diagram illustrating a first exemplary embodiment of controlling a repeater in consideration of operation modes supported by terminals according to the present disclosure, FIG. 24B is a conceptual diagram illustrating a second exemplary embodiment of controlling a repeater in consideration of operation modes supported by terminals according to the present disclosure, and FIG. 24C is a conceptual diagram illustrating a third exemplary embodiment of controlling a repeater in consideration of operation modes supported by terminals according to the present disclosure.

Referring to FIGS. 24A to 24C, in a network operating one or more operation modes, a situation may exist in which terminals having different capabilities for the operation modes coexist. For example, various service scenarios may be possible, such as a situation in which terminals supporting different types of duplex modes all exist within a service area 2405 of a repeater 2400 as illustrated in FIG. 24A, and a situation in which terminals supporting only one type of duplex mode selectively exist as illustrated in FIGS. 24B and 24C.

The network may identify a current state in a service scenario or may predict a future state based on location information of each terminal, a beam identifier (ID) and CSI (e.g. RSRP, RSRQ, SINR, and/or channel quality indicator (CQI)) reported by each terminal, uplink signals amplified and retransmitted by a repeater to a base station, or a combination thereof. Based on the identified current state and/or the predicted future state, the network may indicate, to the repeater, information on a set of operation modes of terminals relayed by the repeater through higher-layer configuration or L1 signaling. Based on such indication, the repeater may additionally consider information on the set of operation modes of terminals relayed by the repeater in addition to operation mode information separately received by the repeater (e.g. SBFD resource allocation information applied to NCR-MT or SBFD resource allocation information applied to NCR-Fwd or an access link), and may perform amplification and retransmission of signals by considering only operation modes valid at a certain time. In other words, amplification and retransmission of signals for an operation mode for which no terminal operating in the operation mode exists during the corresponding time (i.e. an invalid operation mode) may be configured or indicated not to be performed, or may be promised by technical specifications. The operation of amplification and retransmission of signals may also be referred to as a relay operation.

When a time resource to which NCR access link beam indication is applied overlaps with a time resource to which the second operation mode is applied, the NCR access link beam indication may be promised, may be configured by a higher layer, or may be indicated through L1 signaling, not to be applied to a frequency resource to which the second operation mode is applied in the overlapping time resource. This may indicate that NCR-Fwd is turned OFF for the frequency resource to which the second operation mode is applied in the overlapping time resource.

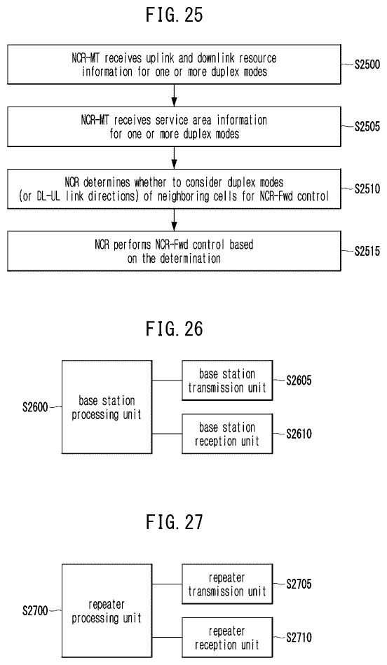

FIG. 25 is a sequence diagram for describing an operation of an NCR according to an exemplary embodiment of the present disclosure.

In step S2500, NCR-MT of an NCR may receive, from a base station, information on uplink and downlink time, frequency, space, or code resources for at least one of a first operation mode and a second operation mode. For example, when NCR-MT of the NCR receives only information on the first operation mode from the base station, NCR-MT may receive uplink time, frequency, space, or code resources of the first operation mode and downlink time, frequency, space, or code resources of the first operation mode. As another example, when NCR-MT of the NCR receives only information on the second operation mode from the base station, NCR-MT may receive uplink time, frequency, space, or code resources of the second operation mode and downlink time, frequency, space, or code resources of the second operation mode. As still another example, when NCR-MT receives both information on the first operation mode and information on the second operation mode, NCR-MT may receive the following information. NCR-MT may receive uplink time, frequency, space, or code resources of the first operation mode, downlink time, frequency, space, or code resources of the first operation mode, uplink time, frequency, space, or code resources of the second operation mode, and downlink time, frequency, space, or code resources of the second operation mode. In the present disclosure, information on the first operation mode and information on the second operation mode may be respectively received through configuration information. In addition, information on the first operation mode may be received from a first base station, and information on the second operation mode may be received from a second base station. The first base station and the second base station may refer to base stations having different PCIs. In other words, the first base station and the second base station may indicate different cells, respectively.

In step S2505, NCR-MT of the NCR may receive, from the base station, service area information for at least one operation mode among operation modes allocated by the base station. The service area information may include information on an area to which different duplex modes are applied, as described in FIG. 23B.

In step S2510, the NCR may determine, based on the information received in step S2500 and step S2505, whether neighboring cells, neighboring areas, or cross-link interference need to be additionally considered when controlling NCR-Fwd (e.g. NCR-Fwd ON or OFF control, power control, or DL-UL direction control). Since this has been described in detail above, a redundant description is omitted.

In step S2515, the NCR may control the NCR-Fwd operation according to the determination of step S2510. The control of the NCR-Fwd operation may be performed on a resource unit basis based on specific slots or symbols, as described above with reference to FIG. 21.

Meanwhile, in an actual implementation of the repeater, the exemplary embodiments described above do not need to be mutually exclusive. In other words, various exemplary embodiments may be implemented in combination. In addition, the repeater may report, to the base station, information on which functions among the functions of the exemplary embodiments are implemented or not implemented. Based on such information, the base station may indicate, to the repeater, which operation the repeater is to perform through L1 signaling or higher-layer signaling. Various other applications are possible, but are omitted in order not to obscure the gist of the description.

FIG. 26 is a conceptual diagram of a base station configuration according to an exemplary embodiment of the present disclosure.

Referring to FIG. 26, a base station may include a base station processing unit 2600, a base station transmission unit 2605, and a base station reception unit 2610. Although not illustrated in FIG. 26, the base station may further include one or more memories of various forms, for example, read-only memory (ROM), random access memory (RAM), a hard disk, or an optical disk. In addition, the base station may further include an interface for communication with a core network and/or an adjacent base station. The configuration illustrated in FIG. 26 is merely an example, and each configuration of an actual base station may be further subdivided or configured in an integrated form according to an exemplary embodiment of the present disclosure or an operator's intention.

The base station processing unit 2600 may determine and process overall operations of the base station according to the exemplary embodiments of the present disclosure. The base station processing unit 2600 may store various types of information and procedures for determination and processing, or may control the base station transmission unit 2605 or the base station reception unit 2610 to appropriately transmit and receive radio signals. In addition, the base station processing unit 2600 may determine which method among the methods of the first exemplary embodiment and the second exemplary embodiment is to be used, and may indicate the determined method to a repeater. The base station processing unit 2600 may be implemented with one or more processors, or as a processor and a memory.

The base station transmission unit 2605 may transmit higher-layer signaling messages, L2 signaling messages, and/or L1 signaling messages that the base station intends to transmit to a repeater and/or a terminal. In addition, the base station transmission unit 2605 may transmit data directly to a terminal or transmit data to a terminal via a repeater. The base station transmission unit 2605 may include components capable of transmitting various signaling messages and/or data. For example, the base station transmission unit 2605 may include components for outputting an RF signal by coding, modulating, performing band up-conversion, and amplifying a signal (e.g. signaling message or data) to be transmitted to a repeater or a terminal.

The base station reception unit 2610 may receive a signal and/or data from a terminal or a repeater. The base station reception unit 2610 may include components capable of receiving an RF signal from a terminal or a repeater and performing operations such as conversion to a baseband signal, demodulation, and decoding.

FIG. 27 is a conceptual diagram of a repeater configuration according to an exemplary embodiment of the present disclosure.

Referring to FIG. 27, a repeater may include a repeater processing unit 2700, a repeater transmission unit 2705, and a repeater reception unit 2710. Although not illustrated in FIG. 27, the repeater may further include one or more memories of various forms, for example, ROM, RAM, a hard disk, or an optical disk. The configuration of FIG. 27 is merely an example, and each configuration of an actual repeater may be further subdivided or configured in an integrated form according to an exemplary embodiment of the present disclosure or an operator's intention. The repeater processing unit 2700 may determine and process overall operations of the repeater according to the exemplary embodiments of the present disclosure. For such processing, the repeater processing unit 2700 may store various types of information and procedures, or may control the repeater transmission unit 2705 or the repeater reception unit 2710 to appropriately transmit and/or receive radio signals.

The repeater reception unit 2710 may receive a signal (e.g. signaling or data) from a terminal or a base station. The received signal may be provided to the repeater processing unit 2700, or may be provided to the repeater transmission unit 2705 to be transmitted to a counterpart (i.e. a base station when the signal is received from a terminal, or a terminal when the signal is received from a base station).

The repeater transmission unit 2705 may simply amplify and transmit a signal transmitted from a terminal to a base station, and/or may process and transmit the signal. In addition, the repeater transmission unit 2705 may simply amplify and transmit a signal transmitted from a base station to a terminal, and/or may process and transmit the signal.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a repeater, the method comprising:
performing a first relay operation between a first base station and a first terminal based on first configuration information for a first operation mode received from the first base station;
performing a second relay operation between a second base station and a second terminal based on second configuration information for a second operation mode received from the second base station; and
based on a preconfigured condition being satisfied, stopping the second relay operation,
wherein the preconfigured condition is received from the first base station through signaling.

2. The method according to claim 1, wherein the preconfigured condition is satisfied based on a second distance between the second base station and the repeater being longer than a first distance between the first base station and the repeater.

3. The method according to claim 2, wherein the first distance and the second distance are radio distances based on signal attenuation, respectively.

4. The method according to claim 2, wherein the first distance is a geometric distance between the repeater and the first base station, and the second distance is a geometric distance between the repeater and the second base station.

5. The method according to claim 4, wherein the first distance is calculated using location information of the first base station included in the first configuration information and location information of the repeater, the second distance is calculated using location information of the second base station included in the second configuration information and the location information of the repeater, and the location information of the repeater is obtained from global navigation satellite system (GNSS) information or is obtained based on a reference signal (RS) received from one of the first base station or the second base station.

6. The method according to claim 1, wherein the preconfigured condition is satisfied based on a second distance between the second base station and the repeater being greater than a preconfigured second threshold.

7. The method according to claim 1, wherein the preconfigured condition is satisfied based on a first distance between the first base station and the repeater being smaller than a preconfigured first threshold.

8. The method according to claim 1, wherein the preconfigured condition is satisfied based on resources for the first relay operation according to the first configuration information overlapping at least partially with resources for the second relay operation according to the second configuration information.

9. The method according to claim 1, wherein the preconfigured condition is satisfied based on the second relay operation being invalid at a specific time.

10. The method according to claim 1, wherein the first operation mode is one of a time division duplexing (TDD) mode, a frequency division duplexing (FDD) mode, or a semi-static TDD mode, and the second operation mode is one of a dynamic TDD mode, a subband non-overlapping full duplex (SBFD) mode, or an inband full duplex (FD) mode.

11. A repeater comprising at least one processor, wherein the at least one processor cause the repeater to perform:
performing a first relay operation between a first base station and a first terminal based on first configuration information for a first operation mode received from the first base station;
performing a second relay operation between a second base station and a second terminal based on second configuration information for a second operation mode received from the second base station; and
based on a preconfigured condition being satisfied, stopping the second relay operation,
wherein the preconfigured condition is received from the first base station through signaling.

12. The repeater of claim 11, wherein the preconfigured condition is satisfied based on a second distance between the second base station and the repeater being longer than a first distance between the first base station and the repeater.

13. The repeater of claim 12, wherein the first distance and the second distance are radio distances based on signal attenuation, respectively.

14. The repeater of claim 12, wherein the first distance is a geometric distance between the repeater and the first base station, and the second distance is a geometric distance between the repeater and the second base station.

15. The repeater of claim 14, wherein the first distance is calculated using location information of the first base station included in the first configuration information and location information of the repeater, the second distance is calculated using location information of the second base station included in the second configuration information and the location information of the repeater, and the location information of the repeater is obtained from global navigation satellite system (GNSS) information or is obtained based on a reference signal (RS) received from one of the first base station or the second base station.

16. The repeater of claim 11, wherein the preconfigured condition is satisfied based on a second distance between the second base station and the repeater being greater than a preconfigured second threshold.

17. The repeater of claim 11, wherein the preconfigured condition is satisfied based on a first distance between the first base station and the repeater being smaller than a preconfigured first threshold.

18. The repeater of claim 11, wherein the preconfigured condition is satisfied based on resources for the first relay operation according to the first configuration information overlapping at least partially with resources for the second relay operation according to the second configuration information.

19. The repeater of claim 11, wherein the preconfigured condition is satisfied based on the second relay operation being invalid at a specific time.

20. The repeater of claim 11, wherein the first operation mode is one of a time division duplexing (TDD) mode, a frequency division duplexing (FDD) mode, or a semi-static TDD mode, and the second operation mode is one of a dynamic TDD mode, a subband non-overlapping full duplex (SBFD) mode, or an inband full duplex (FD) mode.
